(19) United States
(12) Patent Application Publication
(10) Pub. No.: US 2024/0331938 A1
(43) Pub. Date: Oct. 3, 2024

(54) INDUCTIVE COIL ASSEMBLY AND METHOD OF PRODUCING THE SAME

(71) Applicant: Rogers Corporation, Chandler, AZ (US)

(72) Inventors: Vitali JUDIN, Karlsruhe (DE); Rebecca AGAPOV, Bear, DE (US); Christopher J. CAISSE, Kingstown, RI (US); Johannes WIESEND, Kirchenthumbach (DE); Karl Edward SPRENTALL, Medford, MA (US)

(21) Appl. No.: 18/621,813

(22) Filed: Mar. 29, 2024

Related U.S. Application Data
(60) Provisional application No. 63/456,414, filed on Mar. 31, 2023.

(51) Int. Cl. H01F 41/04; H01F 27/28; H01F 41/10; H01F 41/12

(52) U.S. Cl. CPC H01F 41/041; H01F 27/2871; H01F 41/10; H01F 41/122; H01F 2027/2809

(57) ABSTRACT

A method of producing an inductive coil assembly includes forming N(i) layers, (i) being an integer from 1 to M, N(i) being an i-th layer, and N(M) being a maximum number of N(i) layers; stacking and registering the N(1) to N(M) layers such that for (i=1 to M−1), an instance of the first conductor of an N(i+1) layer is adjacent an instance of the second conductor of an N(i) layer; stacking and registering a third conductor having a thickness with the first conductor of the N(1) layer, and a fourth conductor having a thickness with the second conductor of the corresponding N(M) layer; and bonding the third conductor to the first conductor of the N(1) layer, and the fourth conductor to the second conductor of the N(M) layer.

### CROSS REFERENCE TO RELATED APPLICATIONS

This application claims the benefit of U.S. Provisional Application Ser. No. 63/456,414, filed Mar. 31, 2023, which is incorporated herein by reference in their entireties.

### BACKGROUND

The present disclosure relates generally to an inductive coil assembly and a method of producing the same.

Low loss inductive coils with integrated capacitance are useful in the field of inductive wireless power transfer, among other technical fields requiring high-performance magnetic components capable of operating at high-frequency alternating current.

Inductive wireless power transfer provides an easy method for powering and recharging mobile electronic devices, such as smartphones. To enable this technology to reach a broader audience and charge higher power items, the technology needs to be high efficiency and manufacturable in a low-cost, high-volume method. These higher power items may include electric passenger vehicles, forklifts, material handling equipment, buses, or automated guided vehicles.

The state of the art includes Litz wire-based chargers, as well as stacked multilayer conductors. The Litz wire solution uses a primary winding formed of foil or Litz wire that is galvanically isolated. Other state of the art devices include a magnetic self-resonating structure (MSRS).

The following publications may be considered as useful background art: U.S. Pat. Nos. 8,683,682; 8,377,240; 8,974,914; US 2005/0150935; U.S. Pat. No. 10,109,413; WO 2022/015703; L. Gu, G. Zulauf, A. L. F. Stein, P. A. Kyaw, T. Chen and J. M. Rivas Davila, “6.78 MHz Wireless Power Transfer with Self-Resonant Coils at 95% DC-DC Efficiency,” in IEEE Transactions on Power Electronics, doi: 10.1109/TPEL.2020.3014042; Aaron L. F. Stein, Phyo Aung Kyaw, Student Member IEEE, and Charles R. Sullivan, Fellow, IEEE, “Wireless Power Transfer Utilizing a High-Q Self-Resonant Structure”; and, Aaron L. F. Stein Phyo Aung Kyaw Jesse Feldman-Stein Charles R. Sullivan Thayer School of Engineering, Dartmouth College, Hanover, NH 03755 USA, “Thin Self-Resonant Structures with a High-Q for Wireless Power Transfer”.

While existing multi-layer conductors for an electronic component may be suitable for their intended purpose, the art relating to an inductive coil assembly and method of producing the same would be advanced by structure and production methods disclosed herein.

### BRIEF SUMMARY

An embodiment includes a method of producing an inductive coil assembly as defined by the appended independent claims. Further advantageous modifications of the method of producing an inductive coil assembly are defined by the appended dependent claims.

In an embodiment, a method of producing an inductive coil assembly includes: forming a first outer layer having a first conductor bonded to a first side of a first ceramic, wherein a second side of the first ceramic opposes the first side of the first ceramic, wherein the first conductor has a thickness T; forming N(i) intermediate layers, where (i) is an integer from 1 to M, where N(i) represents a discrete one of an i-th intermediate layer, and where N(M) is a defined maximum number of the N(i) intermediate layers, wherein each one of the N(i) intermediate layers includes: an (i) instance of a second conductor bonded to a first side of a corresponding (i) instance of a second ceramic, wherein a second side of the corresponding (i) instance of the second ceramic opposes the first side of the corresponding (i) instance of the second ceramic, and wherein the corresponding (i) instance of the second conductor has a thickness T. The method further including: forming a second outer layer having a third conductor bonded to a first side of a third ceramic, wherein a second side of the third ceramic opposes the first side of the third ceramic, wherein the third conductor has a thickness T; stacking the N(1) to N(M) intermediate layers with the first outer layer such that a corresponding instance of the second conductor of the N(1) intermediate layer is disposed adjacent the second side of the first ceramic of the first outer layer; stacking the second outer layer with the corresponding N(M) intermediate layer such that the third conductor of the second outer layer is disposed adjacent a corresponding instance of the second ceramic of the corresponding N(M) intermediate layer; registering the corresponding instance of the second conductor of the N(1) intermediate layer with the first ceramic of the first outer layer, and the third conductor of the second outer layer with the corresponding instance of the second ceramic of the corresponding N(M) intermediate layer; stacking and registering a fourth conductor with the second side of the third ceramic of the second outer layer; and, directly bonding at least the corresponding instance of the second conductor of the N(1) intermediate layer to the first ceramic of the first outer layer, and the fourth conductor to the third ceramic of the second outer layer.

In an embodiment, a method of producing an inductive coil assembly includes: forming a first outer layer having a first conductor bonded to a first side of a first ceramic, and a second conductor bonded to a second side of the first ceramic, wherein the second side of the first ceramic opposes the first side of the first ceramic, wherein the first conductor has a thickness T, and wherein the second conductor has a thickness (y)T; forming at least one intermediate layer having an instance of a third conductor bonded to a first side of an instance of a second ceramic, and an instance of a fourth conductor bonded to a second side of the instance of the second ceramic, wherein the second side of the instance of the second ceramic opposes the first side of the instance of the second ceramic, wherein the instance of the third conductor has a thickness (x)T, and wherein the instance of the fourth conductor has thickness (y)T; forming a second outer layer having a fifth conductor bonded to a first side of a third ceramic, and a sixth conductor bonded to a second side of the third ceramic, wherein the second side of the third ceramic opposes the first side of the third ceramic, wherein the fifth conductor has a thickness (x)T and wherein the sixth conductor has a thickness T; wherein x is equal to or greater than 0 and equal to or less than 1, and wherein x plus y is equal to 1; stacking the at least one intermediate layer with the first outer layer, such that the third conductor of the at least one intermediate layer is disposed adjacent the second conductor of the first outer layer; stacking the second outer layer with the at least one intermediate layer, such that the fifth conductor of the second outer layer is disposed adjacent the instance of the fourth conductor of the at least one intermediate layer; registering the instance of the third conductor of the at least one intermediate layer with the second conductor of the first outer layer, and the fifth conductor of the second outer layer with the instance of the fourth conductor of the at least one intermediate layer; and, directly bonding the instance of the third conductor of the at least one intermediate layer to the second conductor of the first outer layer, and the fifth conductor of the second outer layer with the instance of the fourth conductor of the at least one intermediate layer.

In an embodiment, a method of producing an inductive coil assembly includes: forming a first outer layer comprising a first conductor bonded to a first side of a first ceramic, and a second conductor bonded to a second side of the first ceramic, wherein the second side of the first ceramic opposes the first side of the first ceramic, wherein the first conductor has a thickness T, and wherein the second conductor has a thickness (y)T; forming N(i) intermediate layers, where (i) is an integer from 1 to M, where N(i) represents a discrete one of an i-th intermediate layer, and where N(M) is a defined maximum number of the N(i) intermediate layers, wherein each one of the N(i) intermediate layers includes: an (i) instance of a third conductor bonded to a first side of a corresponding (i) instance of a second ceramic, and an (i) instance of a fourth conductor bonded to a second side of the corresponding (i) instance of the second ceramic, wherein the second side of the corresponding (i) instance of the second ceramic opposes the first side of the corresponding (i) instance of the second ceramic, wherein the corresponding (i) instance of the third conductor has a thickness (x)T, and wherein the corresponding (i) instance of the fourth conductor has thickness (y)T. The method further including: forming a second outer layer comprising a fifth conductor bonded to a first side of a third ceramic, and a sixth conductor bonded to a second side of the third ceramic, wherein the second side of the third ceramic opposes the first side of the third ceramic, wherein the fifth conductor has a thickness (x)T and wherein the sixth conductor has a thickness T; wherein x is equal to or greater than 0 and equal to or less than 1, and wherein x plus y is equal to 1; stacking the N(1) to N(M) intermediate layers with the first outer layer such that a corresponding instance of the third conductor of the N(1) intermediate layer is disposed adjacent the second conductor of the first outer layer; stacking the second outer layer with the N(M) intermediate layer such that the fifth conductor of the second outer layer is disposed adjacent a corresponding instance of the fourth conductor of the N(M) intermediate layer; registering the corresponding instance of the third conductor of the N(1) intermediate layer with the second conductor of the first outer layer, and the fifth conductor of the second outer layer with the corresponding instance of the fourth conductor of the N(M) intermediate layer; and, directly bonding at least the corresponding instance of the third conductor of the N(1) intermediate layer to the second conductor of the first outer layer, and the fifth conductor of the second outer layer with the corresponding instance of the fourth conductor of the N(M) intermediate layer.

In an embodiment, a method of producing an inductive coil assembly includes: forming N(i) layers, where (i) is an integer from 1 to M, where N(i) represents a discrete one of an i-th layer, and where N(M) is a defined maximum number of the N(i) layers, wherein each one of the N(i) layers includes: an (i) instance of a first conductor bonded to a first side of an (i) instance of a ceramic, wherein a second side of the corresponding (i) instance of the ceramic opposes the first side of the corresponding (i) instance of the ceramic; an (i) instance of a second conductor bonded to the corresponding second side of the (i) instance of the ceramic; and, wherein the (i) instance of the first conductor has a thickness (x)T, and the (i) instance of the second conductor has a thickness (y)T. The method further including: stacking and registering the N(1) to N(M) layers with each other, such that for (i=1 to M−1), a corresponding instance of the first conductor of an N(i+1) layer is disposed adjacent a corresponding instance of the second conductor of an N(i) layer; stacking and registering a third conductor with the corresponding instance of the first conductor of the N(1) layer, and a fourth conductor with the corresponding instance of the second conductor of the corresponding N(M) layer; and, directly bonding at least the third conductor to the corresponding first conductor of the N(1) layer, and the fourth conductor to the corresponding second conductor of the corresponding N(M) layer, wherein the third conductor has a thickness (y)T, and the fourth conductor has a thickness (x)T; wherein x is equal to or greater than 0 and equal to or less than 1, and wherein x plus y is equal to 1.

As herein disclosed, use of direct bonding of a conductor to a ceramic has the surprising effect and unexpected advantage of allowing for the production and utilization of an inductive coil assembly operable at high power with no dielectric breakdown, in a particular frequency operating range, in a compact design. The current Society of Automotive Engineers (SAE) specification J2954 indicates that a wireless charger for a passenger electric vehicle should operate at 85 kHz and transfer 11 kW of power. While embodiments disclosed herein may be suitable for operation in accordance with SAE J2954, it will be appreciated that the scope of the appended claims should not be interpreted as being so limiting, as other frequencies and/or power transfers are contemplated and considered to be within the scope of the appended claims. Larger vehicles, such as a bus, heavy truck, require more power transfer and a material set that can withstand those power levels without shorting or melting.

The above features and advantages and other features and advantages of the invention are readily apparent from the following detailed description of the invention when taken in connection with the accompanying drawings.

### BRIEF DESCRIPTION OF THE DRAWINGS

Referring to the exemplary non-limiting drawings wherein like elements are numbered alike in the accompanying Figures:

FIG. 1A depicts a partial cross-section view of an example single-sided conductor-ceramic layered arrangement for an inductive coil assembly, in accordance with an embodiment;

FIG. 1B depicts a partial cross-section view of another example single-sided conductor-ceramic layered arrangement similar to that of FIG. 1A, but depicting a gap at ends of the conductor layer with and without an offset, in accordance with an embodiment;

FIG. 2A depicts a partial cross-section view of an example double-sided conductor-ceramic layered arrangement for an inductive coil assembly, in accordance with an embodiment;

FIG. 2B depicts a partial cross-section view of another example double-sided conductor-ceramic layered arrangement similar to that of FIG. 2A, but depicting a gap at ends of the conductor layer without an offset, in accordance with an embodiment;

FIG. 2C depicts a partial cross-section view of another example double-sided conductor-ceramic layered arrangement similar to that of FIG. 2B, but depicting a gap at ends of the conductor layer with an offset, in accordance with an embodiment;

FIG. 2D depicts a partial cross-section view of another example double-sided conductor-ceramic layered arrangement similar to that of FIG. 2C, but depicting a gap at ends of the conductor layer with an offset more substantial than that in FIG. 2C, in accordance with an embodiment;

FIG. 3 depicts a partial cross-section view of another example double-sided conductor-ceramic layered arrangement similar to that of FIG. 2A, but with the outer conductor layer formed by an alternative method, in accordance with an embodiment;

FIG. 4A depicts a partial cross-section view of an example bonded conductor-ceramic layered arrangement with and without electrical connections between adjacent conductor layers, and with an example registration pin, in accordance with an embodiment;

FIG. 4B depicts a partial cross-section view of another example bonded conductor-ceramic layered arrangement similar to that of FIG. 4A, but with an alternative example registration pin arrangement, in accordance with an embodiment;

FIG. 4C depicts a rotated isometric view of a portion of an electrical connection that electrically connects the third and fourth conductor layers from the bottom, and does not connect the first and second conductor layers from the bottom, in accordance with an embodiment;

FIG. 4D depicts a rotated isometric view of a portion of an electrical connection similar to that of FIG. 4C, where the first and third conductor layers from the bottom are electrically connected, and where the second and fourth conductor layers from the bottom are not connected, in accordance with an embodiment;

FIG. 5A depicts a top-down plan view of an A-conductor layer and a B-conductor layer with electrical interconnects between every other conductor layer arranged in a spiral, and with assembly registration pins depicted, in accordance with an embodiment;

FIG. 5B depicts a top-down plan view of another A-conductor layer and another B-conductor layer with electrical interconnects between every other conductor layer similar to that of FIG.5A, but with the electrical connections alternatively disposed, in accordance with an embodiment;

FIG. 5C depicts a top-down plan view of another A-conductor layer and another B-conductor layer with electrical interconnects between every other conductor layer similar to that of FIG. 5A, but with the electrical connections edgewise alternatively disposed, in accordance with an embodiment;

FIG. 5D depicts a top-down plan view of another A-conductor layer and another B-conductor layer with electrical interconnects between every other conductor layer similar to that of FIG. 5C, but with the electrical connections edgewise alternatively disposed, in accordance with an embodiment;

FIG. 6A depicts a top-down plan view of an A′-conductor layer and a B′-conductor layer with electrical interconnects between every other conductor layer similar to that of FIG. 5A, but with a structured conductor path in a rectangular arrangement, in accordance with an embodiment;

FIG. 6B depicts a top-down plan view of another A′-conductor layer and another B′-conductor layer with electrical interconnects between every other conductor layer similar to that of FIG. 5B, but with a structured conductor path in a rectangular arrangement, in accordance with an embodiment;

FIG. 6C depicts a top-down plan view of another A′-conductor layer and another B′-conductor layer similar to that of FIG. 6B, but with the electrical connections edgewise alternatively disposed, in accordance with an embodiment; and

FIG. 6D depicts a top-down plan view of another A′-conductor layer and another B′-conductor layer similar to that of FIG. 6C, but with a stepped conductor as viewed in the top-down plan view, in accordance with an embodiment.

As used herein, reference to a plan view is synonymous with reference to an x-y plane of an x-y-z orthogonal coordinate system.

One skilled in the art will understand that the drawings, further described herein below, are for illustration purposes only. It will be appreciated that for simplicity and clarity of illustration, elements shown in the figures have not necessarily been drawn to scale. For example, the dimensions or scale of some of the elements may be exaggerated relative to other elements for clarity. Further, where considered appropriate, reference numerals may be repeated among the figures to indicate corresponding or analogous elements, or analogous elements may not be repetitively enumerated in all figures where it will be appreciated and understood that such enumeration where absent is inherently disclosed.

### DETAILED DESCRIPTION

As used herein, the phrase “embodiment” means “embodiment disclosed and/or illustrated herein”, which may not necessarily encompass a specific embodiment of an invention in accordance with the appended claims, but nonetheless is provided herein as being useful for a complete understanding of an invention in accordance with the appended claims.

Although the following detailed description contains many specifics for the purposes of illustration, anyone of ordinary skill in the art will appreciate that many variations and alterations to the following details are within the scope of the appended claims. For example, where described features may not be mutually exclusive of and with respect to other described features, such combinations of non-mutually exclusive features are considered to be inherently disclosed herein. Additionally, common features may be commonly illustrated in the various figures but may not be specifically enumerated in all figures for simplicity, but would be recognized by one skilled in the art as being an explicitly disclosed feature even though it may not be enumerated in a particular figure. Accordingly, the following example embodiments are set forth without any loss of generality to, and without imposing limitations upon, the claimed invention disclosed herein.

An embodiment, as shown and described by the various figures and accompanying text, provides an improved method for the manufacture of a MSRS device. This enables a multilayer structure of copper and ceramic, with remarkably high adhesion between the metal-ceramic layers, which can withstand high power and a wide operating temperature range. This method balances the high performance required with manufacturing costs, the two hurdles for widespread adoption of the technology. The range, efficiency, and size of the coils in the MSRS device is determined by the quality factor, Q, of the resonant coils. As disclosed herein, high Q structures based on state-of-the-art coils are manufactured using low-cost materials in a low-cost manufacturing process. In addition, this process uses a base material with a high dielectric breakdown strength, which serves to increase the power output of the charging device.

A starting material of pure copper (99% or greater) bonded to a ceramic structure, such as aluminum oxide (Al₂O₃), is produced using a direct bond copper process (DBC). This process is an elevated temperature melting and diffusion process where the pure copper is bonded onto the ceramic. An extraordinarily strong bond is created through the copper-oxygen eutectic that forms and wets the interface surface during the DBC process.

In an embodiment, after the copper is bonded to the ceramic surface, the copper is patterned with the state-of-the-art coil structure. In an embodiment, the structure is developed through print and etch processing techniques. This process is repeated for the number of conductor layers required to achieve the resonant frequency and Q of the coil. The conductor layers are then bonded together through an elevated temperature treatment process, mitigating the need for additional soldering or adhesive layers that can add complexity and cost to the manufacturing process.

In addition to the manufacturing process described above, it is also possible to start with thin patterned layers of foil. The patterning may occur through di-cutting or blade cutting. This patterned layer is placed onto the ceramic surface. Bonding occurs through the same direct bond copper process as detailed above. The patterned layers can then be stacked on top of one another and bonded into a single multilayer structure through an elevated temperature treatment process. This process mitigates the need for print and etch processing of each individual conductor layer.

Due to the high dielectric constant of the ceramic base material, the number of layers required to achieve the electrical resonance of the target operating frequency can be reduced compared to a low dielectric constant base material. An example of an operating frequency of 85 kHz suitable for an embodiment disclosed herein has been set by SAE J2954 as the unified charging frequency for passenger electric vehicles. This decreased number of layers can decrease the cost of the overall manufacturing process due to decreased material costs, as well as decreased layers to print and etch.

In an embodiment, a design as disclosed herein is useful for a MSRS coil. In an embodiment of the processing, strategic areas between the ceramic layers where the patterned copper is absent may be filled with non-conductive material or non-contacting copper material. If these areas are not filled with a non-electrically conductive material or a non-contacting electrically conductive material, large pressure and/or temperature gradients may occur during the multilayer bonding process. These gradients can result in the ceramic warping, or cracking.

After the multilayer assembly is bonded, an embodiment includes a process where the assembly is filled with a polymeric material in areas between the ceramic layers where the patterned copper is absent. This material is used to fill the gaps between the copper features, as well as seal the edges of the structure. Air provides very low dielectric breakdown strength. It is therefore preferable to displace the air with a polymer material with higher dielectric breakdown strength. This will prevent electrical discharge and reinforce the structure, so that mechanical oscillations or vibrations during use (such as attached to a vehicle) do not damage the structure.

An embodiment, as shown and described by the various figures and accompanying text, provides an inductive coil and various methods of producing the same. While the embodiment described herein depicts both a spiral pattern and a rectangular pattern for a structured conductor layer of the inductive coil, it will be appreciated that the disclosed invention is not so limited and is also applicable to other shapes for the current path of the structured conductor layer that fall within an ambit of the appended claims.

Reference is now made to the various figures provided herewith, where several of the figures should be viewed and considered in conjunction with other ones of the several figures.

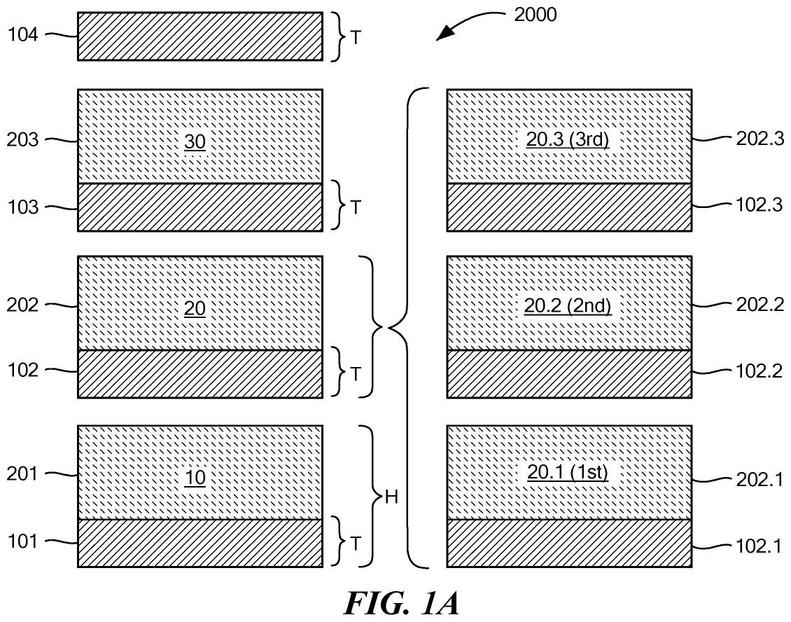

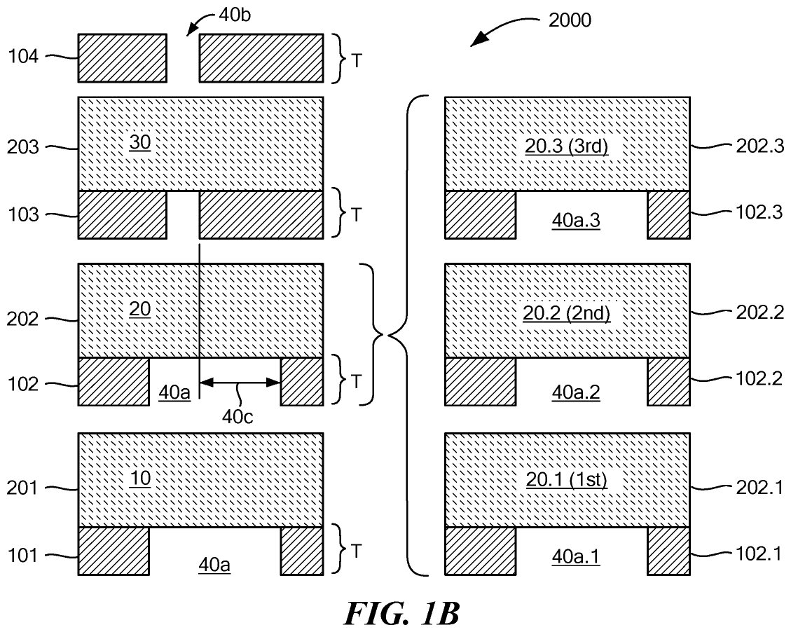

FIGS. 1A-1B depict different partial cross-section views of an example single-sided conductor-ceramic layering arrangement for an inductive coil assembly, where the layering arrangement serves to depict a method of producing an inductive coil assembly 2000 (depicted in a disassembled assembly view), which in an embodiment includes:
forming a first outer layer 10 having a first conductor 101 bonded to a first side of a first ceramic 201, wherein a second side of the first ceramic 201 opposes the first side of the first ceramic 201, wherein the first conductor 101 has a thickness T;
forming N(i) intermediate layers 20, where (i) is an integer from 1 to M, where N(i) represents a discrete one of an i-th intermediate layer 20.1, 20.2, 20.3 . . . , and where N(M) is a defined maximum number of the N(i) intermediate layers, wherein each one of the N(i) intermediate layers 20 includes:
an (i) instance of a second conductor 102.1, 102.2, 102.3 bonded to a first side of a corresponding (i) instance of a second ceramic 202.1, 202.2, 202.3, wherein a second side of the corresponding (i) instance of the second ceramic 202.1, 202.2, 202.3 opposes the first side of the corresponding (i) instance of the second ceramic 202.1, 202.2, 202.3, and wherein the corresponding (i) instance of the second conductor 102.1, 102.2, 102.3 has a defined thickness T;
forming a second outer layer 30 having a third conductor 103 bonded to a first side of a third ceramic 203, wherein a second side of the third ceramic 203 opposes the first side of the third ceramic 203, wherein the third conductor 103 has the thickness T;
stacking the N(1) to N(M) intermediate layers 20.1, 20.2, 20.3 with the first outer layer 10 such that a corresponding instance of the second conductor 102.1 of the N(1) intermediate layer 20.1 is disposed adjacent the second side of the first ceramic 201 of the first outer layer 10;
stacking the second outer layer 30 with the corresponding N(M) intermediate layer 20.1, 20.2, 20.3 such that the third conductor 103 of the second outer layer 30 is disposed adjacent a corresponding instance of the second ceramic 202.1, 202.2, 202.3 of the corresponding N(M) intermediate layer 20.1, 20.2, 20.3;
registering the corresponding instance of the second conductor 102.1 of the N(1) intermediate layer 20.1 with the first ceramic 201 of the first outer layer 10, and the third conductor 103 of the second outer layer 30 with the corresponding instance of the second ceramic 202.1, 202.2, 202.3 of the corresponding N(M) intermediate layer 20.1, 20.2, 20.3;
stacking and registering a fourth conductor 104 with the second side of the third ceramic 203 of the second outer layer 30; and
directly bonding at least the corresponding instance of the second conductor 102.1 of the N(1) intermediate layer 20.1 to the first ceramic 201 of the first outer layer 10, and the fourth conductor 104 to the third ceramic 203 of the second outer layer 30.

As used herein, the maximum value of M is not a fixed number, as the number of layers in a given stack is not only dependent on the component design for a particular purpose, but is also dependent on material properties such as the dielectric constant, Dk, value of the ceramic material used. As such, the maximum value of M could be 64, 128, 256, or any other value suitable for a purpose disclosed herein, and any value for M that is suitable for purpose disclosed herein is contemplated and considered to fall within a scope of the appended claims.

In an embodiment, each conductor-ceramic interface of the inductive coil assembly 2000 undergoes a direct bonding process.

In FIG. 1A, the conductor layers are depicted absent a gap between ends of a corresponding conductor layer, while FIG. 1B the conductor layers are depicted with alternatively sized gaps 40a, 40b between ends of the corresponding conductor layer. As depicted in FIG. 1B, conductor layers 101 and 102 have a gap 40a, and conductor layers 103 and 104 have a gap 40b, such that the respective ends of the corresponding conductor layers are not offset with respect to each other for each of the layer pairs 101/102 and 103/104. Alternatively, conductor layer 102 with gap 40a, and conductor layer 103 with gap 40b, are arranged such that at least one of the respective ends of the corresponding conductor layer is offset 40c with respect to the other conductor layer. Another description of this offsetting arrangement is to describe the right-side (end) of conductor layer 103 as partially overlapping the gap 40a of conductor layer 102.

In an embodiment, the method of stacking the N(1) to N(M) intermediate layers 20.1, 20.2, 20.3 further includes: stacking an (i+1) instance (a relative upper layer) of the intermediate layers 20.2, 20.3 with a corresponding (i) instance (a corresponding relative lower layer) of the intermediate layers 20.1, 20.2, such that the corresponding (i+1) instance of the second conductor 102.2, 102.3 of the (i+1) instance of the intermediate layers 20.2, 20.3 is disposed adjacent the corresponding (i) instance of the second ceramic 202.1, 202.2 of the corresponding (i) instance of the intermediate layers 20.1, 20.2.

In an embodiment, the first conductor 101, each (i) instance of the second conductor 102, the third conductor 103, and the fourth conductor 104, each form a corresponding structured conductor having a defined current path (discussed further herein below).

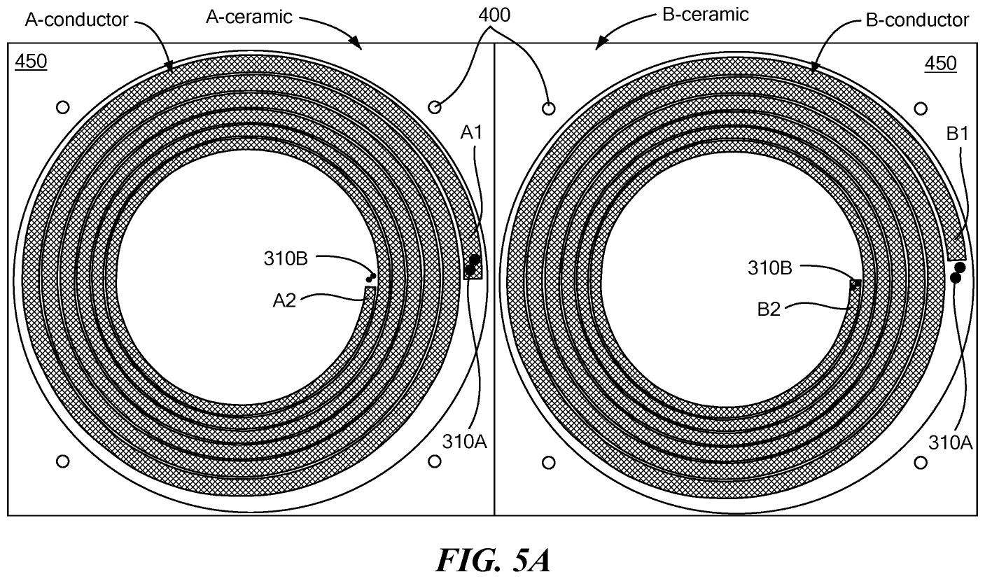

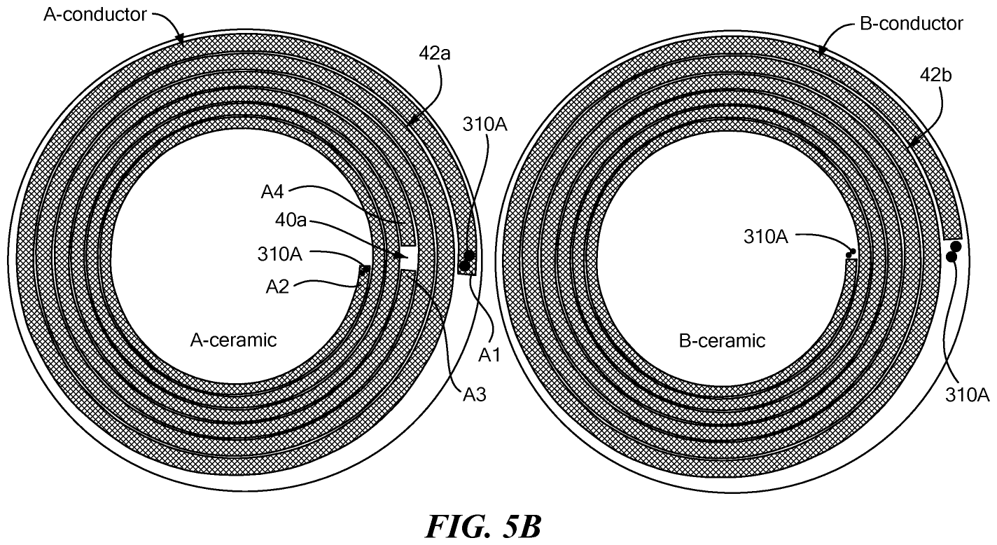

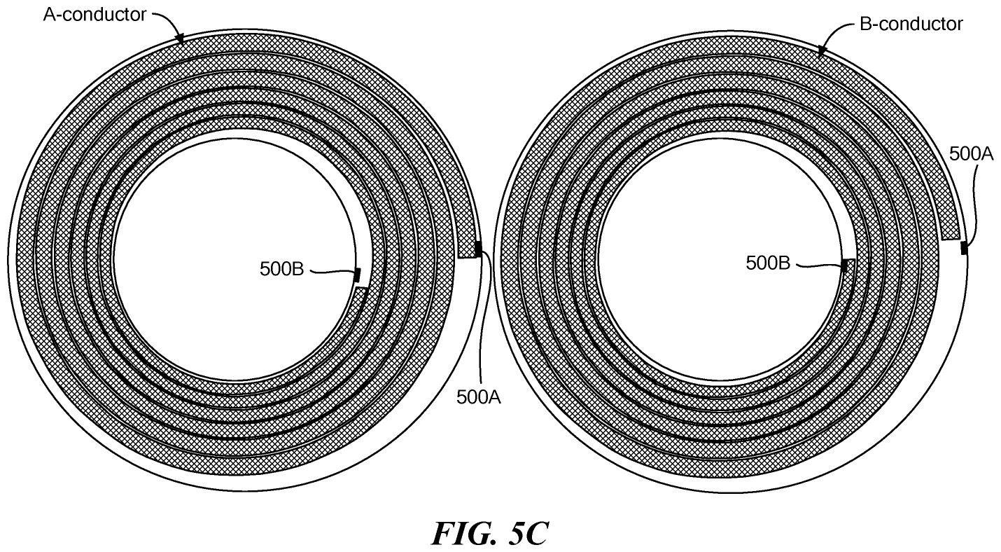

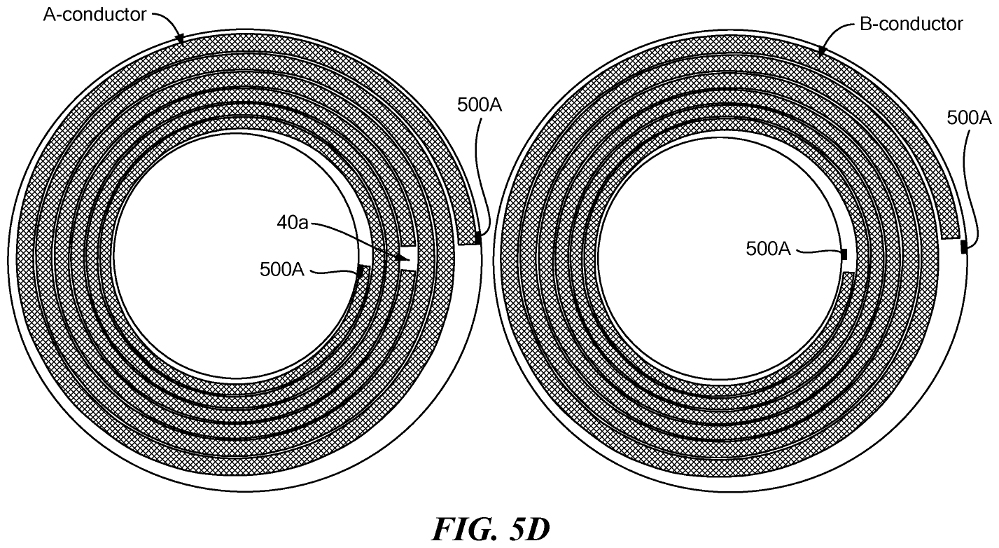

In an embodiment, each of the first structured conductor (herein also referred to by reference numeral 101), the (i) instance of the second structured conductor (herein also referred to by reference numeral 102), the third structured conductor (herein also referred to by reference numeral 103), and the fourth structured conductor (herein also referred to by reference numeral 104), is formed by directly bonding the corresponding conductor to the corresponding ceramic via a DBC process, and patterning the corresponding conductor to form the corresponding structured conductor. In an embodiment, the patterning of the corresponding conductor defines an electrical path, of the corresponding structured conductor from a first end to a second end of the corresponding structured conductor. In an embodiment, at least one of the electrical paths is electrically contiguous and non-interrupted (see FIG. 5A for example). In an embodiment, at least one of the electrical paths is not electrically contiguous and non-interrupted (see FIG. 5B, left image, for example). In an embodiment, the patterning the corresponding conductor includes applying a mask to the corresponding conductor, etching an exposed portion of the corresponding conductor, and removing the mask to define an electrical path of the corresponding structured conductor from a first end to a second end of the corresponding structured conductor.

While the foregoing describes the forming of each structured conductor by patterning the corresponding conductor (non-structured conductor layer), it will be appreciated that embodiments disclosed herein are not so limited. For example, prior to directly bonding the corresponding conductor to the corresponding ceramic, the method can further include forming a defined electrically conductive path in a non-structured conductor to form the corresponding structured conductor. Here, the method step of forming the defined electrically conductive path includes any one of the following: mechanically removing material of the non-structured conductor to form the corresponding structured conductor; mechanically cutting material of the non-structured conductor to form the corresponding structured conductor; mechanically stamping material of the non-structured conductor to form the corresponding structured conductor; optically removing material of the non-structured conductor to form the corresponding structured conductor; and chemically removing material of the non-structured conductor to form the corresponding structured conductor.

In an embodiment, each corresponding structured conductor provides a generally curved electrical current path, or a more specifically defined spiral electrical current path (see FIGS. 5A-5D for example).

Other method steps of forming each structured conductor on a corresponding layer are also contemplated and disclosed herein. For example, the forming of the first outer layer 10, the N(i) intermediate layers 20, the second outer layer 30, or any combination thereof, includes: depositing an additive conductive metal in the form of a structured conductor that directly bonds the structured conductor to a corresponding one of the first ceramic 201, the (i) instance of the second ceramic 202, and the third ceramic 203, wherein the corresponding structured conductor defines an electrical path of a corresponding one of the first, the (i) instance of the second, the third, and the fourth, conductor 101, 102, 103, 104. In an embodiment, the forming of the N(i) intermediate layers 20, includes: depositing an additive conductive metal in the form of a structured conductor that directly bonds the structured conductor to a corresponding one of the (i) instance of the second ceramic 202, wherein the corresponding structured conductor defines an electrical path of a corresponding one of the (i) instance of the second conductor 102.

In an embodiment, any instance of the foregoing conductors is made from copper or aluminum, any instance of the foregoing ceramics is made from aluminum nitride, HPS zirconia doped ceramic, aluminum dioxide, or silicon dioxide.

In an embodiment, the foregoing described thickness T is equal to or greater than 35 microns and equal to or less than 400 microns, or alternatively thickness T is equal to or greater than 65 microns and equal to or less than 200 microns.

In an embodiment, any instance of the foregoing layers has a thickness H of equal to or greater than 70 microns and equal to or less than 1000 microns or alternatively any instance of the foregoing layers has a thickness of equal to or greater than 70 microns and equal to or less than 500 microns.

In an embodiment, any instance of the foregoing structured conductors has a C-shaped edge-wound shape (represented by plan views depicted in FIGS. 5A-5D where the cross-section of the corresponding structured conductor is rectangular for example).

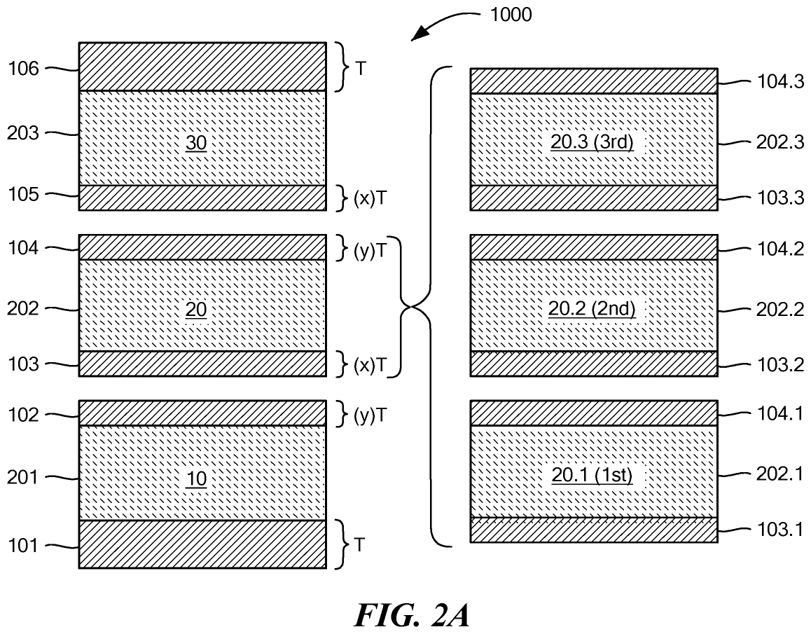

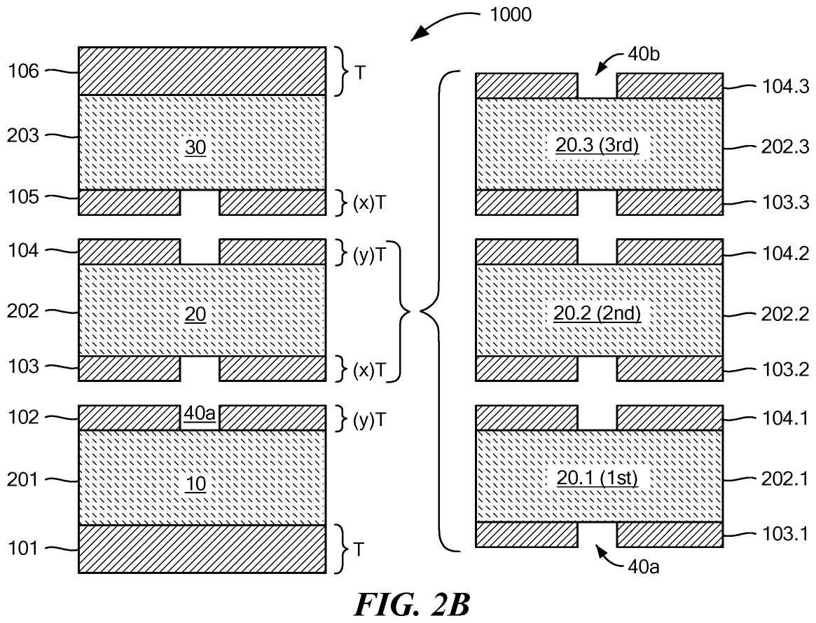

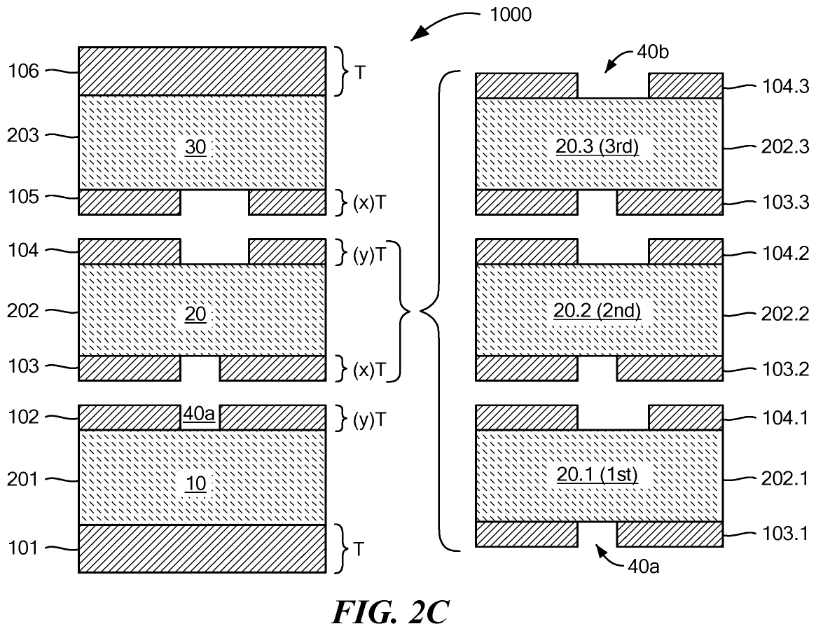

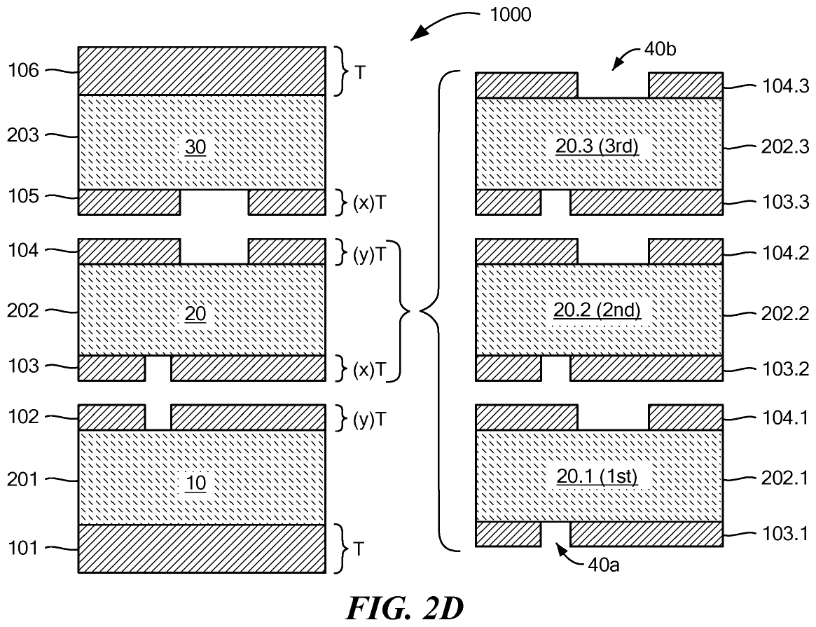

Reference is now made particularly to FIGS. 2A-2D, which depict different partial cross-section views of an example double-sided conductor-ceramic layering arrangement for an inductive coil assembly, where the layering arrangement serves to depict a method of producing an inductive coil assembly 1000 (depicted in a disassembled assembly view), which in an embodiment includes:
forming a first outer layer 10 having a first conductor 101 bonded to a first side of a first ceramic 201, and a second conductor 102 bonded to a second side of the first ceramic 201, wherein the second side of the first ceramic 201 opposes the first side of the first ceramic 201, wherein the first conductor 101 has a thickness T, and wherein the second conductor 102 has a thickness (y)T (i.e., y-times-T);
forming at least one intermediate layer 20 having an instance of a third conductor 103 bonded to a first side of an instance of a second ceramic 202, and an instance of a fourth conductor 104 bonded to a second side of the instance of the second ceramic 202, wherein the second side of the instance of the second ceramic 202 opposes the first side of the instance of the second ceramic 202, wherein the instance of the third conductor 103 has a thickness (x)T (i.e., x-times-T), and wherein the instance of the fourth conductor 104 has thickness (y)T;
forming a second outer layer 30 having a fifth conductor 105 bonded to a first side of a third ceramic 203, and a sixth conductor 106 bonded to a second side of the third ceramic 203, wherein the second side of the third ceramic 203 opposes the first side of the third ceramic 203, wherein the fifth conductor 105 has a thickness (x)T and wherein the sixth conductor 106 has a thickness T;
wherein x is equal to or greater than 0 and equal to or less than 1, and wherein x plus y is equal to 1 (or wherein y is equal to or greater than 0 and equal to or less than 1);
stacking the at least one intermediate layer 20 with the first outer layer 10, such that the third conductor 103 of the at least one intermediate layer 20 is disposed adjacent the second conductor 102 of the first outer layer 10;
stacking the second outer layer 30 with the at least one intermediate layer 20, such that the fifth conductor 105 of the second outer layer 30 is disposed adjacent the instance of the fourth conductor 104 of the at least one intermediate layer 20;
registering the instance of the third conductor 103 of the at least one intermediate layer 20 with the second conductor 102 of the first outer layer 10, and the fifth conductor 105 of the second outer layer 30 with the instance of the fourth conductor 104 of the at least one intermediate layer 20; and
directly bonding the instance of the third conductor 103 of the at least one intermediate layer 20 to the second conductor 102 of the first outer layer 10, and the fifth conductor 105 of the second outer layer 30 with the instance of the fourth conductor 104 of the at least one intermediate layer 20.

From the foregoing reference to variables “x” and “y”, it can be seen that in an embodiment where x=1 and y=0, the layering construct of FIG. 2A is similar to the construct of FIG. 1A. As such, it can be seen that the two layering constructs of FIGS. 1A-1B and FIGS. 2A-2D, are not mutually exclusive.

In an embodiment, the foregoing forming of the at least one intermediate layer 20 of the inductive coil assembly 1000 includes forming a plurality of intermediate layers 20 equal to or greater than two 20.1, 20.2, 20.3, wherein each one of the plurality of intermediate layers 20 includes: the instance of the third conductor 103.1, 103.2, 103.3 bonded to a first side of the instance of the corresponding second ceramic 202.1, 202.2, 202.3, and the instance of the fourth conductor 104.1, 104.2, 104.3 bonded to a second side of the corresponding instance of the second ceramic 202.1, 202.2, 202.3, wherein each instance of the third conductor 103.1, 103.2, 103.3 has a thickness (x)T, and wherein each instance of the fourth conductor 104.1, 104.2, 104.3 has a thickness (y)T.

In an embodiment, the foregoing stacking of the at least one intermediate layer 20 of the inductive coil assembly 1000 includes: stacking a first of the plurality of intermediate layers 20.1 with the first outer layer 10, such that the corresponding instance of the third conductor 103.1 of the first of the plurality of intermediate layers 20.1 is disposed adjacent the second conductor 102 of the first outer layer 10; and, stacking a second of the plurality of intermediate layers 20.2 with the first of the plurality of intermediate layers 20.1, such that the corresponding instance of the third conductor 103.2 of the second of the plurality of intermediate layers 20.2 is disposed adjacent the corresponding instance of the fourth conductor 104.1 of the first of the plurality of intermediate layers 20.1.

In an embodiment, the foregoing stacking of the second outer layer 30 of the inductive coil assembly 1000 includes: stacking the second outer layer 30 with the second of the plurality of intermediate layers 20.2, such that the fifth conductor 105 of the second outer layer 30 is disposed adjacent the corresponding instance of the fourth conductor 104.2 of the second of the plurality of intermediate layers 20.2.

With reference still now particularly to FIGS. 2A-2D, an embodiment of the method of producing the inductive coil assembly 1000, includes:
forming a first outer layer 10 having a first conductor 101 bonded to a first side of a first ceramic 201, and a second conductor 102 bonded to a second side of the first ceramic 201, wherein the second side of the first ceramic 201 opposes the first side of the first ceramic 201, wherein the first conductor 101 has a thickness T, and wherein the second conductor 102 has a thickness (y)T;
forming N(i) intermediate layers 20, where (i) is an integer from 1 to M, where N(i) represents a discrete one of an i-th intermediate layer 20.1, 20.2, 20.3, and where N(M) is a defined maximum number of the N(i) intermediate layers 20, wherein each one of the N(i) intermediate layers 20 includes:
an (i) instance of a third conductor 103.1, 103.2 103.3 bonded to a first side of a corresponding (i) instance of a second ceramic 202.1, 202.2, 202.3, and an (i) instance of a fourth conductor 104.1, 104.2, 104.3 bonded to a second side of the corresponding (i) instance of the second ceramic 202.1, 202.2, 202.3, wherein the second side of the corresponding (i) instance of the second ceramic 202.1, 202.2, 202.3 opposes the first side of the corresponding (i) instance of the second ceramic 202.1, 202.2, 202.3, wherein the corresponding (i) instance of the third conductor 103.1, 103.2, 103.3 has a thickness (x)T, and wherein the corresponding (i) instance of the fourth conductor 104.1, 104.2, 104.3 has thickness (y)T;
forming a second outer layer 30 comprising a fifth conductor 105 bonded to a first side of a third ceramic 203, and a sixth conductor 106 bonded to a second side of the third ceramic 203, wherein the second side of the third ceramic 203 opposes the first side of the third ceramic 203, wherein the fifth conductor 105 has a thickness (x)T and wherein the sixth conductor 106 has a thickness T;
wherein x is equal to or greater than 0 and equal to or less than 1, and wherein x plus y is equal to 1 (or wherein y is equal to or greater than 0 and equal to or less than 1);
stacking the N(1) to N(M) intermediate layers 20.1, 20.2, 20.3 with the first outer layer 10 such that a corresponding instance of the third conductor 103.1 of the N(1) intermediate layer 20.1 is disposed adjacent the second conductor 102 of the first outer layer 10;
stacking the second outer layer 30 with the N(M) intermediate layer 20.1 (where M=1), 20.2 (where M=2), 20.3 (where M=3) such that the fifth conductor 105 of the second outer layer 30 is disposed adjacent a corresponding instance of the fourth conductor 104.1, 104.2, 104.3 of the N(M) intermediate layer 20.1, 20.2, 20.3;
registering the corresponding instance of the third conductor 103.1 of the N(1) intermediate layer 20.1 with the second conductor 102 of the first outer layer 10, and the fifth conductor 105 of the second outer layer 30 with the corresponding instance of the fourth conductor 104.1, 104.2, 104.3 of the N(M) intermediate layer 20.1, 20.2, 20.3; and
directly bonding at least the corresponding instance of the third conductor 103.1 of the N(1) intermediate layer 20.1 to the second conductor 102 of the first outer layer 10, and the fifth conductor 105 of the second outer layer 30 with the corresponding instance of the fourth conductor 104.1, 104.2, 104.3 of the N(M) intermediate layer 20.1, 20.2, 20.3.

In an embodiment, each conductor-ceramic interface of the inductive coil assembly 1000 undergoes a direct bonding (DBC) process.

In an embodiment, the N(i) intermediate layers 20.1, 20.2, 20.3 includes an N(i) instance of the intermediate layers 20.1, 20.2 (a relatively lower one of the intermediate layers) and an N(i+1) instance of the intermediate layers 20.2, 20.3 (a corresponding relatively upper one of the intermediate layers), and wherein the stacking the N(1) to N(M) intermediate layers includes:
stacking the N(i+1) instance of the intermediate layers 20.2, 20.3 with the corresponding N(i) instance of the intermediate layers 20.1, 20.2, such that the corresponding instance of the third conductor 103.2, 103.3 of the N(i+1) instance of the intermediate layers 20.2, 20.3 is disposed adjacent the corresponding instance of the fourth conductor 104.1, 104.2 of the N(i) instance of the intermediate layers 20.1, 20.2.

In an embodiment, the method step of registering in the method of producing the inductive coil assembly 1000, includes registering the corresponding instance of the (upper) third conductor 103.2, 103.3 of the N(i+1) instance of the intermediate layers 20.2, 20.3 with the corresponding instance of the (lower) fourth conductor 104.1, 104.2 of the N(i) instance of the intermediate layers 20.1, 20.2.

In an embodiment, the method step of directly bonding in the method of producing the inductive coil assembly 1000 further includes directly bonding the corresponding instance of the (relatively upper) third conductor 103.2, 103.3 of the N(i+1) instance of the intermediate layers 20.2, 20.3 with the corresponding instance of the (relatively lower) fourth conductor 104.1, 104.2 of the N(i) instance of the intermediate layers 20.1, 20.2.

In comparison to the discussion above regarding FIG. 1B depicting an offsetting arrangement of the conductor layers where the right-side (end) of conductor layer 103 partially overlaps the gap 40a of conductor layer 102, a similar partial overlapping arrangement can be seen in FIG. 2C in layer 20, and a full overlapping arrangement can be seen in FIG. 2D in layer 20.

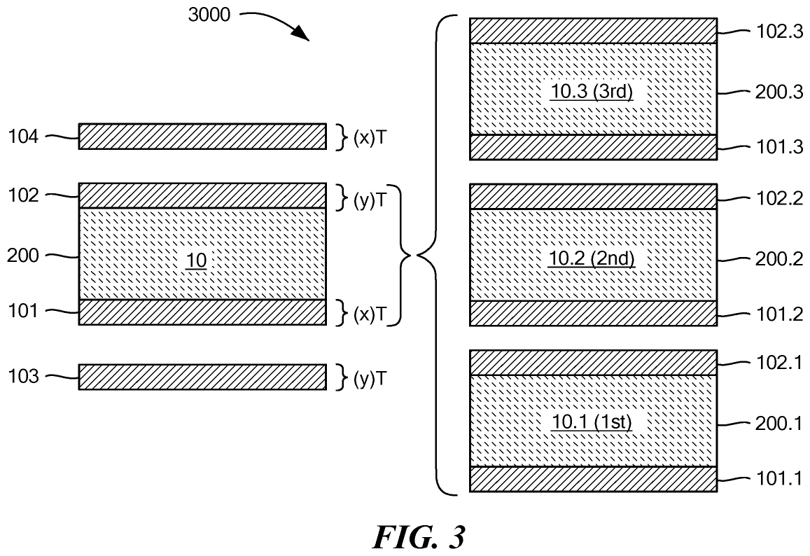

Reference is now made particularly to FIG. 3, which depicts a method of producing an inductive coil assembly 3000 (depicted in a disassembled assembly view) that includes:
forming N(i) layers 10, where (i) is an integer from 1 to M, where N(i) represents a discrete one of an i-th layer 10.1, 10.2, 10.3, and where N(M) is a defined maximum number of the N(i) layers 10, wherein each one of the N(i) layers 10 comprises:
an (i) instance of a first conductor 101.1, 101.2, 101.3 bonded to a first side of an (i) instance of a ceramic 200.1, 200.2, 200.3, wherein a second side of the corresponding (i) instance of the ceramic 200.1, 200.2, 200.3 opposes the first side of the corresponding (i) instance of the ceramic 200.1, 200.2, 200.3;
an (i) instance of a second conductor 102.1, 102.2, 102.3 bonded to the corresponding second side of the (i) instance of the ceramic 200.1, 200.2, 200.3; and wherein the (i) instance of the first conductor 101.1, 101.2, 101.3 has a thickness (x)T, and the (i) instance of the second conductor 102.1, 102.2, 102.3 has a thickness (y)T;
stacking and registering the N(1) to N(M) layers 10.1, 10.2, 10.3 with each other, such that for (i=1 to M−1), a corresponding instance of the first conductor 101.2, 101.3 of an N(i+1) layer 10.2, 10.3 is disposed adjacent a corresponding instance of the second conductor 102.1, 102.2 of an N(i) layer 10.1, 10.2;
stacking and registering a third conductor 103 with the corresponding instance of the first conductor 101.1 of the N(1) layer 10.1, and a fourth conductor 104 with the corresponding instance of the second conductor 102.2, 102.3 of the corresponding N(M) layer 10.2, 10.3; and
directly bonding at least the third conductor 103 to the corresponding first conductor 101.1 of the N(1) layer 10.1, and the fourth conductor 104 to the corresponding second conductor 102.2, 102.3 of the corresponding N(M) layer 10.2, 10.3, wherein the third conductor 103 has a thickness (y)T, and the fourth conductor 104 has a thickness (x)T;
wherein x is equal to or greater than 0 and equal to or less than 1, and wherein x plus y is equal to 1 (or wherein y is equal to or greater than 0 and equal to or less than 1).

In an embodiment, each conductor-conductor interface of the inductive coil assembly 1000 undergoes a direct bonding (DBC) process.

With reference to the inductive coil assembly 3000 depicted in FIG. 3, where i=3 (depicted in the right side of FIG. 3), the resulting assembled and bonded lower conductor 101.1+103, and the resulting assembled and bonded upper conductor 102.3+104, would each have a thickness T and would not be patterned into a structured conductor as discussed herein, while the assembled and bonded intermediate conductors 102.1+101.2, 102.1+101.3, would each have a thickness T and would be patterned into a structures conductor as discussed herein. In an embodiment, the outermost conductor layers of a given inductive coil 1000, 2000, 3000 is not patterned into a structured conductor, as these layers are utilized for other electrical purposes.

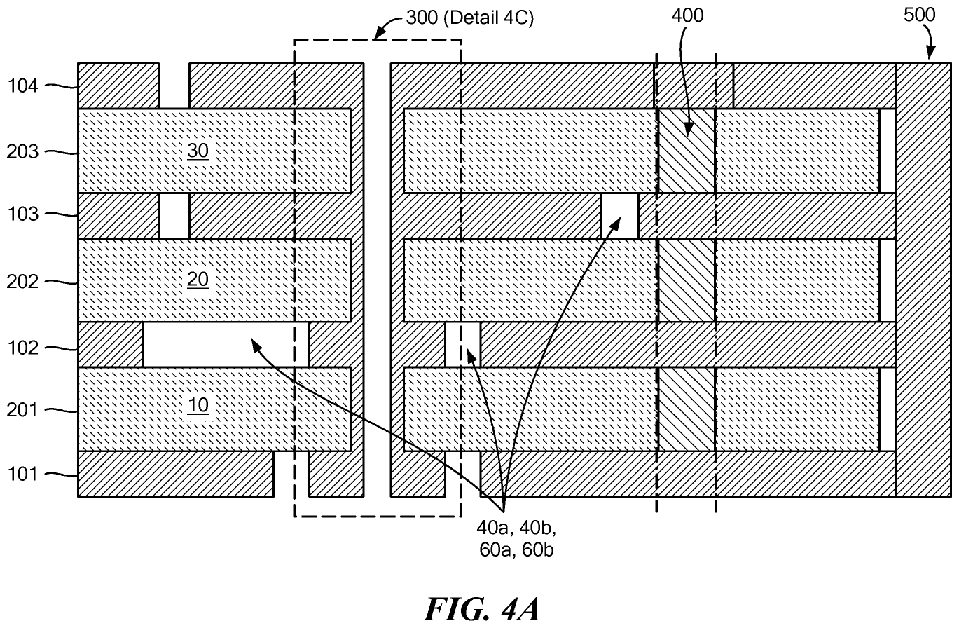

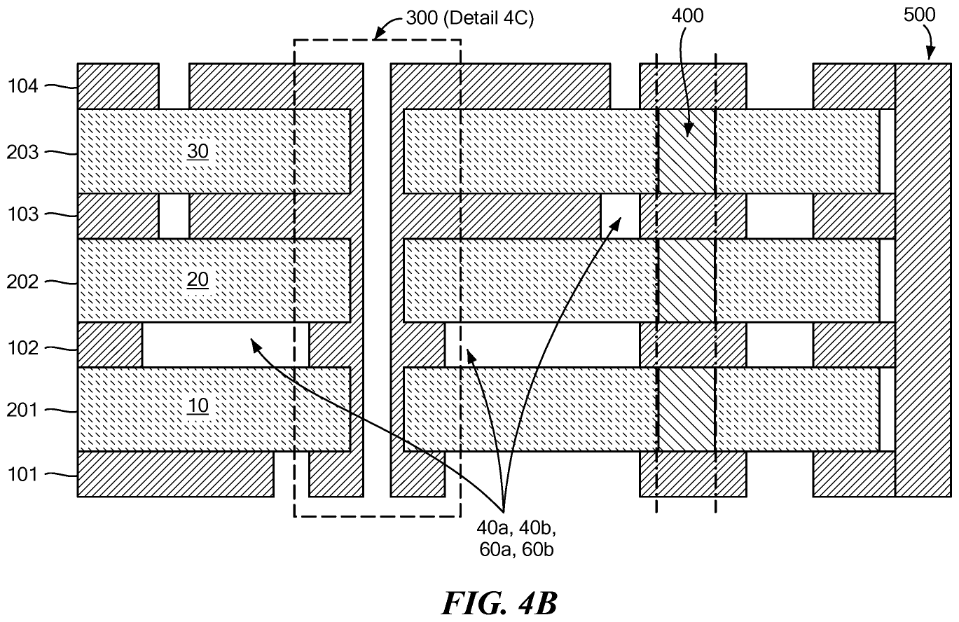

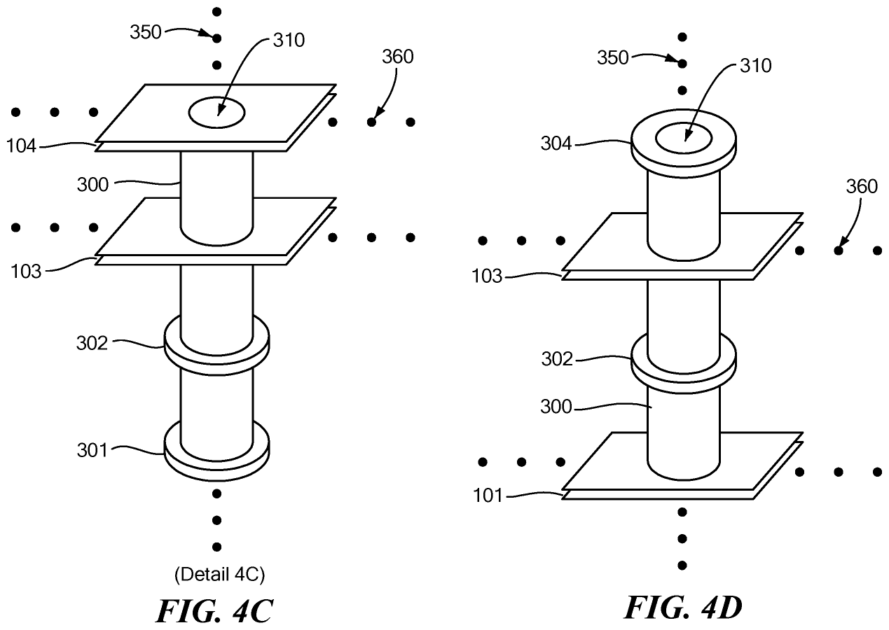

In addition to all of the foregoing and with reference particularly to FIG. 4A, the method of producing any one of the foregoing inductive coils 1000, 2000, 3000 having one or more of the gaps 40a, 40b (see FIGS. 1B and 2C for example), may have the gaps 40a, 40b filled with air. Alternatively, the method of producing any one of the foregoing inductive coils 1000, 2000, 3000 having one or more of the gaps 40a, 40b may further include: providing within a corresponding gap 40a, 40b a first polymer or resin 60a on a same side of the (i) instance of the second ceramic 202.1 as the corresponding (i) instance of the second structured conductor 102.1 (see FIG. 1B, 40a.1 for example); and, providing within the same gap 40a, 40b a second polymer or resin 60b on a same side of the (i+1) instance of the second ceramic 202.2 as the corresponding (i+1) instance of the second structured conductor 102.2 (see FIG. 1B, 40a.2 for example).

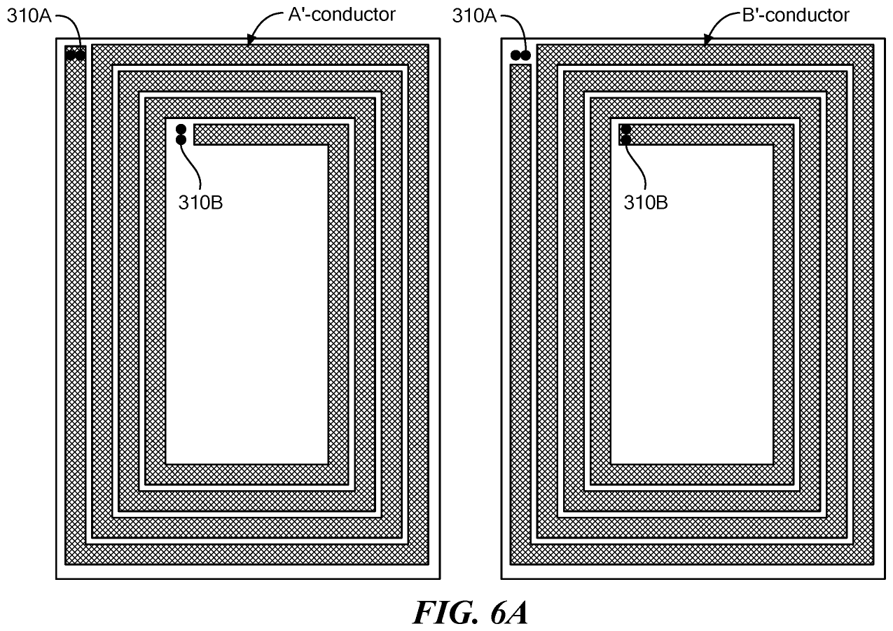

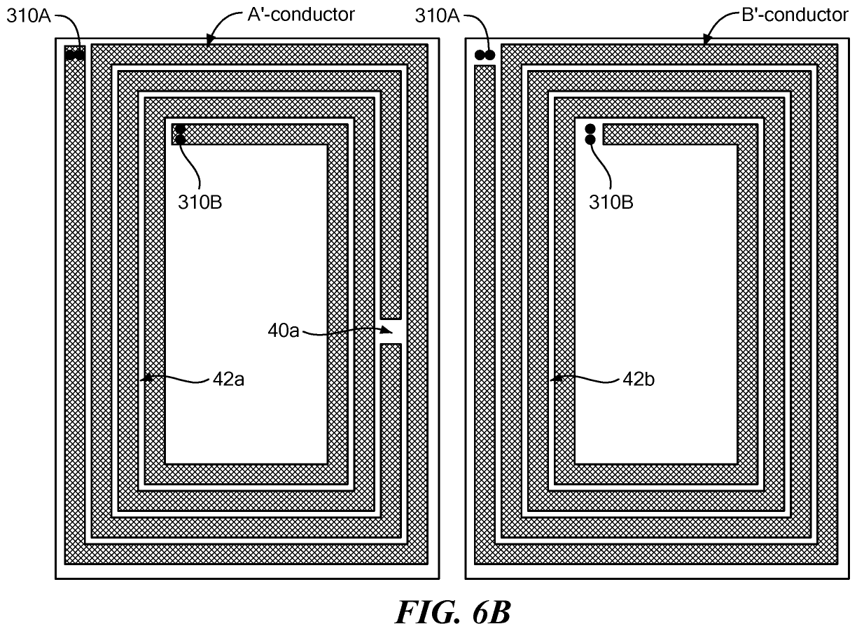

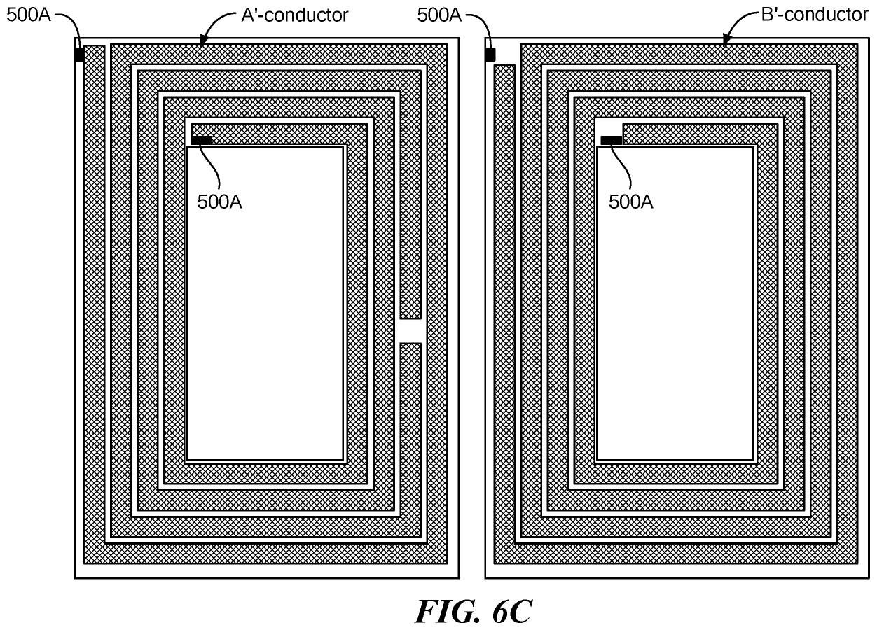

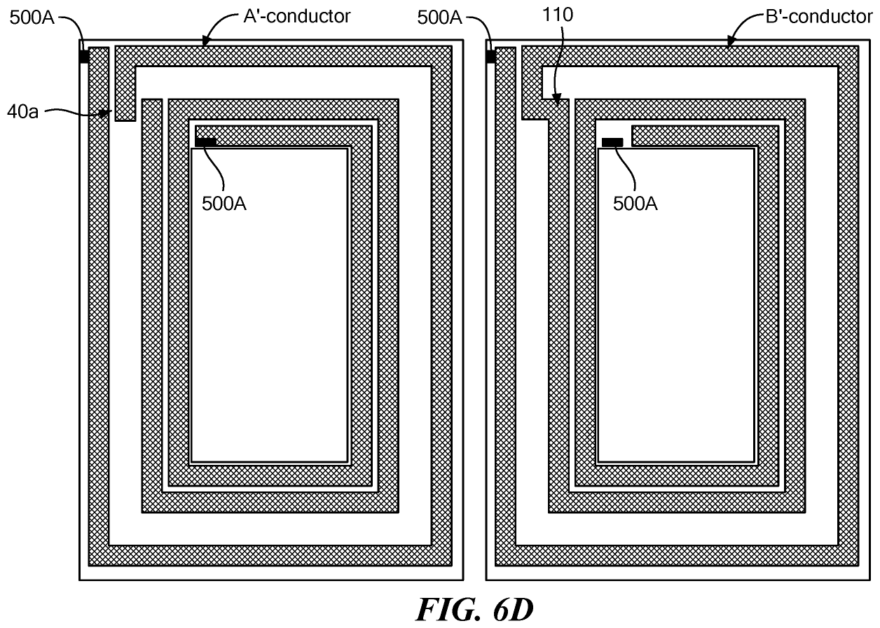

In an embodiment, the first polymer 60a is disposed in an area on the (i) instance of the second ceramic 202.1 that is void of material 40a.1 of the corresponding (i) instance of the second structured conductor 102.1, and the second polymer is disposed in an area of the (i+1) instance of the second ceramic 202.2 that is void of material 40a.2 of corresponding (i+1) instance of the second structured conductor 102.2, where the voids are for example in the gaps 40a, 40b, and/or the spacing 42a, 42b between the windings of the coils (see FIGS. 5B and 6B for example) of the structured conductors 101-104 of the inductive coil 1000, 2000, 3000 (see also FIG. 1B for example).

In an embodiment, the first polymer 60a (which may be in gap 40a.1 for example) has a same thickness as the (i) instance of the second structured conductor 102.1, and the second polymer 60b (which may be in gap 40a.2 for example) has a same thickness as the (i+1) instance of the second structured conductor 102.2.

With consideration to the foregoing and with reference to FIG. 1B, it will be appreciated that an embodiment of the method of producing any inductive coil assembly 1000, 2000, 3000, includes: providing a first polymer 60a on a same side of the first ceramic 201 as the first structured conductor 101; providing an (i) instance of a second polymer 60b on a same side of the (i) instance of the second ceramic 202.1 as the corresponding (i) instance of the second structured conductor 102.1; providing an (i+1) instance of a second polymer 60b on a same side of the (i+1) instance of the second ceramic 202.2 as the corresponding (i+1) instance of second structured conductor 102.2; wherein the first polymer is disposed in an area 40a of the first ceramic 201 that is void of material of the first structured conductor 101; wherein the (i) instance of the second polymer 60b is disposed in an area 40a.1 of the (i) instance of the second ceramic 202.1 that is void of material of the (i) instance of the second structured conductor; and, wherein the (i+1) instance of the second polymer 60b is disposed in an area 40a.1 of the (i+1) instance of the second ceramic 202.2 that is void of material of the (i+1) instance of the second structured conductor 102.2.

In an embodiment of a single-sided conductor-ceramic layered arrangement (see FIG. 1B for example), the first polymer 60a has a same thickness as the second polymer 60a.

In an embodiment of a double-sided conductor-ceramic layered arrangement (see FIG. 2B for example), the first polymer 60a has a same thickness as the second polymer 60a, where the same thickness is equal to T/2.

In an embodiment (with particular reference being made to FIG. 1A), the first outer layer 10, the N(i) intermediate layers 20, and the second outer layer 30, form any inductive coil assembly 2000 (but see also 1000, 3000) having a plurality of electrical conductor layers 101-104, formed by a corresponding one of the first conductor 101, an (i) instance of the second conductor 102.1, 102.2, 102.3, the third conductor 103, and the fourth conductor 104, and ceramic layers 201-203, formed by a corresponding one the first ceramic 201, an (i) instance of the second ceramic 202.1, 202.2, 202.3, and the third ceramic 203, that alternate sequentially with each other.

In an embodiment (with particular reference to FIGS. 1A, and 4A-4C) at least two of adjacent ones of the plurality of electrical conductor layers 103, 104 (see FIGS. 1A and 4C) having the thickness T are electrically connected with each other by way of an electrical connection 300 (See FIGS. 4A-4C) that traverses an intervening one of the plurality of ceramic layers 203 (best seen with reference to FIG. 1A).

In an embodiment (with particular reference being made to FIGS. 1A, 4A, 4B, and 4D), at least two of every other one of the plurality of electrical conductor layers 101, 103 (see FIGS. 1A and 4D) having the thickness T are electrically connected with each other by way of an electrical connection 300 (see FIGS. 4A, 4B, and 4D) that traverses an intervening one, or more than one, of the plurality of ceramic layers 201, 202 (best seen with reference to FIG. 1A).

In an embodiment, the electrical connection 300 includes an integrally formed spacer 301, 302, 304 in the region between adjacent ones of the plurality of plurality of ceramic layers 201, 202, 203, and the spacer 301, 302, 304 is not electrically connected to a corresponding one of the electrical conductor layer at a corresponding one of the layers (101, 102 in FIGS. 1A and 4C; 102, 104 in FIGS. 1A and 4D, for example).

In an embodiment, the electrical connection 300 includes one or more of an electrically filled or electrically plated via 310.

In FIGS. 4C and 4D, the vertical ellipses 350 are representative that the electrical connection 300 may extend up and/or down to include additional intermediate layers 20.1, 20.3, 20.3, and the horizontal ellipses 360 are representative that the corresponding electrical conductors 101, 103, 104 may extend left and/or right to form a structured electrical conductor (best seen with reference to FIGS. 5A-5D, and FIGS. 6A-6D).

FIGS. 4A and 4B depict an edge electrical connection 500 (electrically connected to an edge, outer or inner, of the corresponding structured electrical conductor), which may be used in conjunction with the electrically conductive vias 310, or not. The edge electrical connection is also depicted in, and discussed in connection with, FIGS. 5C, 5D, 6C, and 6D, further herein below.

Reference is now made to FIGS. 4A, 4B, and 5A, which depict one or more registration pins 400 used for registering a plurality of the layers 10, 20, 30, electrical conductor layers 101-104, and ceramic layers 201-203, in a stacked arrangement of a single-sided or double-sided conductor-ceramic layering arrangement for an inductive coil assembly 1000, 2000, 3000, as disclosed herein. While FIGS. 4A and 4B depict the registration pin 400 to appear to pass through the electrical conductor layers, this is not ideal, and preferably a plurality of the registration pins 400 pass through a region of the ceramic layers that is outside of the periphery of the structured electrical conductor layers in a bonded and stacked arrangement, as depicted in top-down plan view in FIG. 5A. Here, and once the stacked layers are registered and bonded together, the outer portion 450 of the stacked layers containing the registration pins and non-functional portions of the ceramic layers can be removed by any means suitable for a purpose disclosed herein to facilitate economic packaging of the inductive coil assembly (FIGS. 5B-5D, as compared to FIG. 5A, depict portion 450 removed, for example).

In an embodiment, each instance of the conductor is formed of a same material as another different instance of the conductor.

With respect to all of the foregoing, it will be appreciated that the method of producing an inductive coil assembly 1000, 2000, 3000 includes a process wherein: the first conductor 101 bonded to the first side of the first ceramic 201, is bonded at a first surface-surface interface; each (i) instance of the second conductor 102.1, 102.2, 102.3 bonded to the first side of the corresponding (i) instance of the second ceramic 202.1, 202.2, 202.3, is bonded at a corresponding (i) instance of a second surface-surface interface; the third conductor 103 bonded to the first side of the third ceramic 203, is bonded at a third surface-surface interface; and, the fourth conductor 104 bonded to the third ceramic 203 of the second outer layer 30, is bonded at a fourth surface-surface interface. And wherein the method of producing further includes a process step of directly bonding via heating and a direct bond copper process through formation of a copper-oxygen eutectic that wets a corresponding one of the first, second, third, and fourth, surface-surface interface.

Alternatively, and also with respect to all of the foregoing, it will be appreciated that the method of producing an inductive coil assembly 1000, 2000, 3000 includes a process wherein: the first conductor 101 bonded to the first side of the first ceramic 201, is bonded at a first surface-surface interface; each (i) instance of the second conductor 102.1, 102.2, 102.3 bonded to the first side of the corresponding (i) instance of the second ceramic 202.1, 202.2, 202.3, is bonded at a corresponding (i) instance of a second surface-surface interface; the third conductor 103 bonded to the first side of the third ceramic 203, is bonded at a third surface-surface interface; and, the fourth conductor 104 bonded to the third ceramic 203 of the second outer layer 30, is bonded at a fourth surface-surface interface. And wherein the method of producing further includes a process step of chemically bonding via application of a bonding agent that wets a corresponding one of the first, second, third, and fourth, surface-surface interface. In an embodiment, the bonding agent includes one or more of: a prepreg material; a polymer paste; and, a ceramic paste.

With respect to all of the foregoing, the method of producing an inductive coil assembly 1000, 2000, 3000 further includes a process step of: in any instance of a foregoing one of the conductor, providing a void 40a, 40b that creates an electrical disconnect in the corresponding conductor (see FIGS. 4B, 5B, and 6B, for example). In an embodiment, each void in the corresponding conductor of adjacently disposed pairs of the conductor are disposed directly facing each other (see FIGS. 1B and 2B). In an embodiment, each void in the corresponding conductor of adjacently disposed pairs of the conductor are disposed not directly facing, but offset with respect to, each other (see FIGS. 1B, 2C, and 2D). In an embodiment, each void in the corresponding conductor of adjacently disposed pairs of the conductor comprise equal gap dimensions (see FIGS. 1B, 2B, 2C, and 2D). In an embodiment, each void in the corresponding conductor of adjacently disposed pairs of the conductor comprise non-equal gap dimensions (see FIGS. 1B, 2C, and 2D). In an embodiment, the method of producing an inductive coil assembly 1000, 2000, 3000 further includes a process step of filling one or more of any instance of a foregoing one of the void with a dielectric material.

Reference is now made to FIGS. 5A-5D, and 6A-6D, which in general depict alternative arrangements of an A-conductor-ceramic layer in the left image, and a B-conductor-ceramic layer in the right image, which are stacked, registered, and bonded, in an alternating arrangement, as disclosed herein, and wherein pairs of adjacent ones of the A-conductors are electrically connected, and pairs of adjacent ones of the B-conductors are electrically connected, in a given stack. In FIGS. 5A-5D, the structured electrical conductors in the A and B layers are in the form of a spiral, while in FIGS. 6A-6D, the structured electrical conductors in the A and B layers are in the form of a rectangle.

In an embodiment and with respect to all of the foregoing, the method of producing an inductive coil assembly 1000, 2000, 3000 further includes: forming the first outer layer 10, the N(i) intermediate layers 20, and the second outer layer 30, to define an A-layer construct and a B-layer construct that alternate with each other in an arrangement of stacked A-B-A-B layers or B-A-B-A layers.

In an embodiment and with respect to all of the foregoing, the method of producing an inductive coil assembly 1000, 2000, 3000 further includes: forming the first conductor 101, each (i) instance of the second conductor 102, the third conductor 103, and the fourth conductor 104, to define an A-conductor construct and a B-conductor construct that alternate with each other in an arrangement of stacked A-B-A-B conductors or B-A-B-A conductors, with corresponding ones of the first ceramic 201, an (i) instance of the second ceramic 202, and the third ceramic 203, disposed between adjacent one of the A and B conductors.

In an embodiment and with reference to FIG. 5A, each A-conductor and each B-conductor is a structured conductor in the form of a plurality of windings having a first outer end A1, B1 and a second inner end A2, B2; wherein the first outer end A1 of a first A-conductor is electrically connected to a next adjacent A-conductor in the stack by way of electrically conductive vias 310A through the B-ceramic; and, wherein the second inner end B2 of a first B-conductor is electrically connected to a next adjacent B-conductor in the stack by way of electrically connected vias 310B through the A-ceramic (see also FIG. 4D).

In an embodiment and with reference to FIG. 5B, the A and B conductors are each formed with smooth electrical paths, absent a stepped electrical path, on each winding, wherein the A-conductor has an electrical disconnect between the corresponding first outer end A1 and the second inner end A2 that forms a third intermediary end A3 and a fourth intermediary end A4 with an electrical gap 40a therebetween, wherein the third intermediary end A3 is electrically connected to the first outer end A1, and the fourth intermediary end A4 is electrically connected to the second inner end A2. The presence of the electrical gap 40a between the third and fourth intermediary ends A3, A4 serves to decouple the capacitance between the A and B layers (see also FIGS. 6B and 6C discussed herein below). Here, the first outer end and the second inner end of an A-conductor are electrically connected to respective ones of the first outer end and the second inner end of a next adjacent A-conductor in the stack by way of electrically connected vias 310A through the B-ceramic.

In an embodiment, corresponding ones of the electrically connected conductors are electrically connected by way of electrically filled or electrically plated vias 300, 310.

In an embodiment and with reference to FIG. 5C, corresponding ones of the electrically connected conductors are electrically connected to a next adjacent one of a corresponding conductor by way of edgewise electrical connections 500 (500A that connect the A-conductors, and 500B that connect the B-conductors).

FIG. 5D depicts features, such as 40a, 500A, for example, similar to those discussed herein above.

As depicted in FIGS. 5A-5D, the respective plurality of windings, A-conductors and B-conductors, have a curved or circular shape, as observed in a plan view of the corresponding layer.

With reference to FIGS. 6A-6B, an embodiment includes an arrangement where the respective plurality of windings, A′-conductors and B′-conductors, have a rectangular or square shape, as observed in a plan view of the corresponding layer. Without the need to go into any further detail, it can be seen that FIGS. 6A-6C depict features, such as 40a, 42a, 42b, 310A, 310B, 500A, for example, similar to those discussed herein above.

In comparison, FIG. 6D not only depicts current paths and edgewise electrical connections similar to those of FIG. 6C, but also depicts a stepped current path in the B′-conductor at step 110, and a capacitive decoupling gap 40a in the A′-conductor. While an x-y plan view of the step 110 is depicted only in FIG. 6D, it will be appreciated that other structured current paths in other configurations in the various figures disclosed herein are possible and contemplated herein. Also, it will be appreciated that the plated via 310 described herein above also serves as a step in a z-direction in the associated current path of the corresponding electrically connected structured conductors.

In an embodiment and with respect to all of the foregoing, any instance of the process step of registering includes use of one or more registration pins 400 (see FIGS. 4A, 4B, and 5A).

In an embodiment, the process step of registering, further includes placing the one or more registration pins 400 in a location such that the one or more registration pins 400 pass through all instances of the ceramic layer.

In an embodiment, the process step of registering, further includes placing the one or more registration pins 400 in a location such that the one or more registration pins 400 do not pass through any instance of the conductor layer.

While certain embodiments disclosed herein depict particular patterns for the structured electrical conductor layers, see FIGS. 5A-5D and 6A-6D for example, it will be appreciated that other patterns for the structured electrical conductor layers is not only possible, but also contemplated herein. Also, it will be appreciated that an inductive coil assembly as disclosed herein having a plurality of structured electrical conductors in the form of windings may have a different number of windings for one or more of the structured electrical conductor layers in the stacked arrangement between the plurality of ceramic layers.

While an invention has been described herein with reference to example embodiments, it will be understood by those skilled in the art that various changes may be made, and equivalents may be substituted for elements thereof without departing from the scope of the claims. Many modifications may be made to adapt a particular situation or material to the teachings of the invention without departing from the essential scope thereof. Therefore, it is intended that the invention not be limited to the particular embodiment or embodiments disclosed herein as the best or only mode contemplated for carrying out this invention, but that the invention will include all embodiments falling within the scope of the appended claims. In the drawings and the description, there have been disclosed example embodiments and, although specific terms and/or dimensions may have been employed, they are unless otherwise stated used in a generic, exemplary and/or descriptive sense only and not for purposes of limitation, the scope of the claims therefore not being so limited. When an element such as a layer, film, region, substrate, or other described feature is referred to as being “on” or in “engagement with” another element, it can be directly on or engaged with the other element, or intervening elements may also be present. In contrast, when an element is referred to as being “directly on” or “directly engaged with” another element, there are no intervening elements present. The use of the terms first, second, etc. do not denote any order or importance, but rather the terms first, second, etc. are used to distinguish one element from another. The use of the terms a, an, etc. do not denote a limitation of quantity, but rather denote the presence of at least one of the referenced items. The use of the terms “top”, “bottom”, “up”, “down”, “left”, “right”, “front”, “back”, etc., or any reference to orientation, do not denote a limitation of structure, as the structure may be viewed from more than one orientation, but rather denote a relative structural relationship between one or more of the associated features as disclosed herein. The term “comprising” as used herein does not exclude the possible inclusion of one or more additional features. And, any background information provided herein is provided to reveal information believed by the applicant to be of possible relevance to the invention disclosed herein. No admission is necessarily intended, nor should be construed, that any of such background information constitutes prior art against an embodiment of the invention disclosed herein.

In view of all of the foregoing, it will be appreciated that various aspects of an embodiment are disclosed herein, which are in accordance with, but not limited to, at least the following aspects and/or combinations of aspects.

Aspect 1: A method of producing an inductive coil assembly 2000, the method comprising: forming a first outer layer 10 comprising a first conductor 101 bonded to a first side of a first ceramic 201, wherein a second side of the first ceramic 201 opposes the first side of the first ceramic 201, wherein the first conductor 101 has a thickness T; forming N(i) intermediate layers 20, where (i) is an integer from 1 to M, where N(i) represents a discrete one of an i-th intermediate layer 20.1, 20.2, 20.3, and where N(M) is a defined maximum number of the N(i) intermediate layers, wherein each one of the N(i) intermediate layers 20 comprises: an (i) instance of a second conductor 102.1, 102.2, 102.3 bonded to a first side of a corresponding (i) instance of a second ceramic 202.1, 202.2, 202.3, wherein a second side of the corresponding (i) instance of the second ceramic 202.1, 202.2, 202.3 opposes the first side of the corresponding (i) instance of the second ceramic 202.1, 202.2, 202.3, and wherein the corresponding (i) instance of the second conductor 102.1, 102.2, 102.3 has a thickness T; forming a second outer layer 30 comprising a third conductor 103 bonded to a first side of a third ceramic 203, wherein a second side of the third ceramic 203 opposes the first side of the third ceramic 203, wherein the third conductor 103 has a thickness T; stacking the N(1) to N(M) intermediate layers 20.1, 20.2, 20.3 with the first outer layer 10 such that a corresponding instance of the second conductor 102.1 of the N(1) intermediate layer 20.1 is disposed adjacent the second side of the first ceramic 201 of the first outer layer 10; stacking the second outer layer 30 with the corresponding N(M) intermediate layer 20.1, 20.2, 20.3 such that the third conductor 103 of the second outer layer 30 is disposed adjacent a corresponding instance of the second ceramic 202.1, 202.2, 202.3 of the corresponding N(M) intermediate layer 20.1, 20.2, 20.3; registering the corresponding instance of the second conductor 102.1 of the N(1) intermediate layer 20.1 with the first ceramic 201 of the first outer layer 10, and the third conductor 103 of the second outer layer 30 with the corresponding instance of the second ceramic 202.1, 202.2, 202.3 of the corresponding N(M) intermediate layer 20.1, 20.2, 20.3; stacking and registering a fourth conductor 104 with the second side of the third ceramic 203 of the second outer layer 30; and, directly bonding at least the corresponding instance of the second conductor 102.1 of the N(1) intermediate layer 20.1 to the first ceramic 201 of the first outer layer 10, and the fourth conductor 104 to the third ceramic 203 of the second outer layer 30.

Aspect 2: The method of Aspect 1, wherein the stacking the N(1) to N(M) intermediate layers 20.1, 20.2, 20.3 further comprises: stacking an (i+1) instance of the intermediate layers 20.2, 20.3 with a corresponding (i) instance of the intermediate layers 20.1, 20.2, such that the corresponding (i+1) instance of the second conductor 102.2, 102.3 of the (i+1) instance of the intermediate layers 20.2, 20.3 is disposed adjacent the corresponding (i) instance of the second ceramic 202.1, 202.2 of the corresponding (i) instance of the intermediate layers 20.1, 20.2.

Aspect 3: The method of any one of Aspects 1 to 2, wherein: the first conductor 101, each (i) instance of the second conductor 102, the third conductor 103, and the fourth conductor 104, each form a corresponding structured conductor.

Aspect 4: The method of Aspect 3, wherein: each of the first structured conductor, the (i) instance of the second structured conductor, the third structured conductor, and the fourth structured conductor, is formed by directly bonding the corresponding conductor to the corresponding ceramic, and patterning the corresponding conductor to form the corresponding structured conductor.

Aspect 5: The method of Aspect 4, wherein: the patterning the corresponding conductor defines an electrical path, of the corresponding structured conductor from a first end to a second end of the corresponding structured conductor.

Aspect 6: The method of Aspect 5, wherein: at least one of the electrical paths is electrically contiguous and non-interrupted.

Aspect 7: The method of Aspect 4, wherein: the patterning the corresponding conductor comprises applying a mask to the corresponding conductor, etching an exposed portion of the corresponding conductor, and removing the mask to define an electrical path of the corresponding structured conductor from a first end to a second end of the corresponding structured conductor.

Aspect 8: The method of Aspect 4, wherein prior to directly bonding the corresponding conductor to the corresponding ceramic, the method further comprising: forming a defined electrically conductive path in a non-structured conductor to form the corresponding structured conductor.

Aspect 9: The method of Aspect 8, wherein the forming the defined electrically conductive path comprises any one of the following: mechanically removing material of the non-structured conductor to form the corresponding structured conductor; mechanically cutting material of the non-structured conductor to form the corresponding structured conductor; mechanically stamping material of the non-structured conductor to form the corresponding structured conductor; optically removing material of the non-structured conductor to form the corresponding structured conductor; and, chemically removing material of the non-structured conductor to form the corresponding structured conductor.

Aspect 10: The method of any one of Aspects 3 to 9, wherein: each corresponding structured conductor comprises a curved electrical current path.

Aspect 11: The method of any one of Aspects 3 to 10, wherein: each corresponding structured conductor comprises a spiral electrical current path.

Aspect 12: The method of any one of Aspects 1 to 11, wherein the forming of the first outer layer, the N(i) intermediate layers, the second outer layer, or any combination thereof, comprises: depositing an additive conductive metal in the form of a structured conductor that directly bonds the structured conductor to a corresponding one of the first ceramic, the (i) instance of the second ceramic, and the third ceramic, wherein the corresponding structured conductor defines an electrical path of a corresponding one of the first, the (i) instance of the second, the third, and the fourth, conductor.

Aspect 13: The method of any one of Aspects 1 to 11, wherein the forming of the N(i) intermediate layers, comprises: depositing an additive conductive metal in the form of a structured conductor that directly bonds the structured conductor to a corresponding one of the (i) instance of the second ceramic, wherein the corresponding structured conductor defines an electrical path of a corresponding one of the (i) instance of the second conductor.

Aspect 14: The method of any one of the foregoing Aspects, wherein: any instance of the conductor comprises copper or aluminum.

Aspect 15: The method of any one of the foregoing Aspects, wherein: any instance of the ceramic comprises aluminum nitride, HPS zirconia doped ceramic, aluminum dioxide, or silicon dioxide.

Aspect 16: The method of any one of the foregoing Aspects, wherein: thickness T is equal to or greater than 35 microns and equal to or less than 400 microns.

Aspect 17: The method of any one of the foregoing Aspects, wherein: thickness T is equal to or greater than 65 microns and equal to or less than 200 microns.

Aspect 18: The method of any one of the foregoing Aspects, wherein: any instance of the layer has a thickness of equal to or greater than 70 microns and equal to or less than 1000 microns.

Aspect 19: The method of any one of the foregoing Aspects, wherein: any instance of the layer has a thickness of equal to or greater than 70 microns and equal to or less than 500 microns.

Aspect 20: The method of any one of Aspects 3 to 11, wherein: any instance of the structured conductor has a C-shaped edge-wound shape.

Aspect 21: The method of any one of Aspects 1-20, wherein: each instance of the conductor is formed of a same material as another different instance of the conductor.

Aspect 22: The method of any one of Aspects 3 to 11, further comprising: providing a first polymer on a same side of the (i) instance of the second ceramic as the corresponding (i) instance of the second structured conductor; and, providing a second polymer on a same side of the (i+1) instance of the second ceramic as the corresponding (i+1) instance of the second structured conductor.

Aspect 23: The method of Aspect 22, wherein: the first polymer is disposed in an area on the (i) instance of the second ceramic that is void of material of the corresponding (i) instance of the second structured conductor; and, the second polymer is disposed in an area of the (i+1) instance of the second ceramic that is void of material of corresponding (i+1) instance of the second structured conductor.

Aspect 24: The method of Aspect 23, wherein: the first polymer has a same thickness as the (i) instance of the second structured conductor; and, the second polymer has a same thickness as the (i+1) instance of the second structured conductor.

Aspect 25: The method of any one of Aspects 3 to 11, further comprising: providing a first polymer on a same side of the first ceramic as the first structured conductor; providing an (i) instance of a second polymer on a same side of the (i) instance of the second ceramic as the corresponding (i) instance of the second structured conductor; providing an (i+1) instance of a second polymer on a same side of the (i+1) instance of the second ceramic as the corresponding (i+1) instance of second structured conductor; wherein the first polymer is disposed in an area of the first ceramic that is void of material of the first structured conductor; wherein the (i) instance of the second polymer is disposed in an area of the (i) instance of the second ceramic that is void of material of the (i) instance of the second structured conductor; and, wherein the (i+1) instance of the second polymer is disposed in an area of the (i+1) instance of the second ceramic that is void of material of the (i+1) instance of the second structured conductor.

Aspect 26: The method of Aspect 25, wherein: the first polymer has a same thickness as the second polymer.

Aspect 27: The method of Aspect 26, wherein: the same thickness is equal to T/2.

Aspect 28: The method of any one of Aspects 1 to 27, wherein: the first outer layer, the N(i) intermediate layers, and the second outer layer, form the inductive coil assembly having a plurality of electrical conductor layers, formed by a corresponding one of the first conductor, an (i) instance of the second conductor, the third conductor, and the fourth conductor, and ceramic layers, formed by a corresponding one the first ceramic, an (i) instance of the second ceramic, and the third ceramic, that alternate sequentially with each other.

Aspect 29: The method of Aspect 28, wherein: at least two of every other one of the plurality of electrical conductor layers having the thickness T are electrically connected with each other by way of an electrical connection that traverses an intervening one of the plurality of ceramic layers.

Aspect 30: The method of Aspect 28, wherein: at least two of adjacent ones of the plurality of electrical conductor layers having the thickness T are electrically connected with each other by way of an electrical connection that traverses an intervening one of the plurality of ceramic layers.

Aspect 31: The method of any one of Aspect 29 to 30, wherein: the electrical connection includes an integrally formed spacer in the region between adjacent ones of the plurality of plurality of ceramic layers; the spacer not being electrically connected to a corresponding one of the electrical conductor layer at a corresponding one of the layers.

Aspect 32: The method of any one of Aspects 29 to 31, wherein: the electrical connection comprises one or more of an electrically filled or electrically plated via

Aspect 33: The method of any one of Aspects 1 to 32, wherein: the first conductor 101 bonded to the first side of the first ceramic 201, is bonded at a first surface-surface interface; each (i) instance of the second conductor 102.1, 102.2, 102.3 bonded to the first side of the corresponding (i) instance of the second ceramic 202.1, 202.2, 202.3, is bonded at a corresponding (i) instance of a second surface-surface interface; the third conductor 103 bonded to the first side of the third ceramic 203, is bonded at a third surface-surface interface; and, the fourth conductor 104 bonded to the third ceramic 203 of the second outer layer 30, is bonded at a fourth surface-surface interface; the method further comprising: directly bonding via heating and a direct bond copper process through formation of a copper-oxygen eutectic that wets a corresponding one of the first, second, third, and fourth, surface-surface interface.

Aspect 34: The method of any one of Aspects 1 to 32, wherein: the first conductor 101 bonded to the first side of the first ceramic 201, is bonded at a first surface-surface interface; each (i) instance of the second conductor 102.1, 102.2, 102.3 bonded to the first side of the corresponding (i) instance of the second ceramic 202.1, 202.2, 202.3, is bonded at a corresponding (i) instance of a second surface-surface interface; the third conductor 103 bonded to the first side of the third ceramic 203, is bonded at a third surface-surface interface; and, the fourth conductor 104 bonded to the third ceramic 203 of the second outer layer 30, is bonded at a fourth surface-surface interface; the method further comprising: chemically bonding via application of a bonding agent that wets a corresponding one of the first, second, third, and fourth, surface-surface interface.

Aspect 35: The method of Aspect 34, wherein: the bonding agent comprises one or more of: a prepreg material; a polymer paste; and, a ceramic paste.

Aspect 36: The method of any one of the preceding Aspects, further comprising: in any instance of the conductor, providing a void that creates an electrical disconnect in the corresponding conductor.

Aspect 37: The method of Aspect 36, wherein: each void in the corresponding conductor of adjacently disposed pairs of the conductor are disposed directly facing each other.

Aspect 38: The method of Aspect 37, wherein: each void in the corresponding conductor of adjacently disposed pairs of the conductor are disposed not directly facing, but offset with respect to, each other.

Aspect 39: The method of any one of Aspects 36 to 38, wherein: each void in the corresponding conductor of adjacently disposed pairs of the conductor comprise equal gap dimensions.

Aspect 40: The method of any one of Aspects 36 to 38, wherein: each void in the corresponding conductor of adjacently disposed pairs of the conductor comprise non-equal gap dimensions.

Aspect 41: The method of any one of Aspects 33 to 37, further comprising: filling one or more of any instance of the void with a dielectric material.

Aspect 42: The method of any one of Aspects 1 to 41, further comprising: forming the first outer layer, the N(i) intermediate layers, and the second outer layer, to define an A-layer construct and a B-layer construct that alternate with each other in an arrangement of stacked A-B-A-B layers or B-A-B-A layers.

Aspect 43: The method of any one of Aspects 1 to 42, further comprising: forming the first conductor, each (i) instance of the second conductor, the third conductor, and the fourth conductor, to define an A-conductor construct and a B-conductor construct that alternate with each other in an arrangement of stacked A-B-A-B conductors or B-A-B-A conductors, with corresponding ones of the first ceramic, an (i) instance of the second ceramic, and the third ceramic, disposed between adjacent one of the A and B conductors.

Aspect 44: The method of Aspect 43, wherein: each A-conductor and each B-conductor comprise a structured conductor in the form of a plurality of windings having a first outer end and a second inner end; the first outer end of an A-conductor is electrically connected to a respective first outer end of a next adjacent A-conductor; and, the second inner end of a B-conductor is electrically connected to a respective second inner end of a next adjacent B-conductor.

Aspect 45: The method of Aspect 44, wherein: at least one of the A-conductor and the B-conductor are each formed with a step in the electrical path, on one or more of the windings.

Aspect 46: The method of Aspect 45, wherein: the step is oriented in either a z-direction, or in an x-y plane of an orthogonal x-y-z coordinate system.

Aspect 47: The method of any one of Aspects 45 to 46, wherein: the A-conductor comprises an electrical disconnect between the corresponding first outer end and the second inner end that forms a third intermediary end and a fourth intermediary end with an electrical gap therebetween; the third intermediary end is electrically connected to the first outer end; and, the fourth intermediary end is electrically connected to the second inner end.

Aspect 48: The method of Aspect 47, wherein: the first outer end and the second inner end of an A-conductor are electrically connected to respective ones of the first outer end and the second inner end of a next adjacent A-conductor.

Aspect 49: The method of any one of Aspects 45 to 48, wherein: corresponding ones of the electrically connected conductors are electrically connected by way of electrically filled or electrically plated vias.

Aspect 50: The method of any one of Aspects 45 to 48, wherein: corresponding ones of the electrically connected conductors are electrically connected by way of edgewise electrical connections.

Aspect 51: The method of any one of Aspects 45 to 50, wherein: the respective plurality of windings has a curved or circular shape, as observed in a plan view of the corresponding layer.

Aspect 52: The method of any one of Aspects 45 to 50, wherein: the respective plurality of windings has a rectangular or square shape, as observed in a plan view of the corresponding layer.

Aspect 53: The method of any one of the foregoing Aspects, wherein: any instance of the registering comprises use of one or more registration pins.

Aspect 54: The method of Aspect 53, further comprising: placing the one or more registration pins in a location such that the one or more registration pins pass through all instances of the ceramic.

Aspect 55: The method of Aspect 54, further comprising: placing the one or more registration pins in a location such that the one or more registration pins do not pass through any instance of the conductor.

Aspect 56: A method of producing an inductive coil assembly 1000, the method comprising: forming a first outer layer 10 comprising a first conductor 101 bonded to a first side of a first ceramic 201, and a second conductor 102 bonded to a second side of the first ceramic 201, wherein the second side of the first ceramic 201 opposes the first side of the first ceramic 201, wherein the first conductor 101 has a thickness T, and wherein the second conductor 102 has a thickness (y)T; forming at least one intermediate layer 20 comprising an instance of a third conductor 103 bonded to a first side of an instance of a second ceramic 202, and an instance of a fourth conductor 104 bonded to a second side of the instance of the second ceramic 202, wherein the second side of the instance of the second ceramic 202 opposes the first side of the instance of the second ceramic 202, wherein the instance of the third conductor 103 has a thickness (x)T, and wherein the instance of the fourth conductor 104 has thickness (y)T; forming a second outer layer 30 comprising a fifth conductor 105 bonded to a first side of a third ceramic 203, and a sixth conductor 106 bonded to a second side of the third ceramic 203, wherein the second side of the third ceramic 203 opposes the first side of the third ceramic 203, wherein the fifth conductor 105 has a thickness (x)T and wherein the sixth conductor 106 has a thickness T; wherein x is equal to or greater than 0 and equal to or less than 1, and wherein x plus y is equal to 1; stacking the at least one intermediate layer 20 with the first outer layer 10, such that the third conductor 103 of the at least one intermediate layer 20 is disposed adjacent the second conductor 102 of the first outer layer 10; stacking the second outer layer 30 with the at least one intermediate layer 20, such that the fifth conductor 105 of the second outer layer 30 is disposed adjacent the instance of the fourth conductor 104 of the at least one intermediate layer 20; registering the instance of the third conductor 103 of the at least one intermediate layer 20 with the second conductor 102 of the first outer layer 10, and the fifth conductor 105 of the second outer layer 30 with the instance of the fourth conductor 104 of the at least one intermediate layer 20; and, directly bonding the instance of the third conductor 103 of the at least one intermediate layer 20 to the second conductor 102 of the first outer layer 10, and the fifth conductor 105 of the second outer layer 30 with the instance of the fourth conductor 104 of the at least one intermediate layer 20.

Aspect 57: The method of Aspect 56, wherein the forming at least one intermediate layer 20 comprises: forming a plurality of intermediate layers equal to or greater than two 20.1, 20.2, 20.3, wherein each one of the plurality of intermediate layers comprises: the instance of the third conductor 103.1, 103.2, 103.3 bonded to a first side of the corresponding instance of the second ceramic 202.1, 202.2, 202.3, and the instance of the fourth conductor 104.1, 104.2, 104.3 bonded to a second side of the corresponding instance of the second ceramic 202.1, 202.2, 202.3, wherein each instance of the third conductor 103.1, 103.2, 103.3 has a thickness (x)T, and wherein each instance of the fourth conductor 104.1, 104.2, 104.3 has a thickness (y)T.

Aspect 58: The method of Aspect 57, wherein the stacking the at least one intermediate layer 20 comprises: stacking a first of the plurality of intermediate layers 20.1 with the first outer layer 10, such that the corresponding instance of the third conductor 103.1 of the first of the plurality of intermediate layers 20.1 is disposed adjacent the second conductor 102 of the first outer layer 10; and, stacking a second of the plurality of intermediate layers 20.2 with the first of the plurality of intermediate layers 20.1, such that the corresponding instance of the third conductor 103.2 of the second of the plurality of intermediate layers 20.2 is disposed adjacent the corresponding instance of the fourth conductor 104.1 of the first of the plurality of intermediate layers 20.1.

Aspect 59: The method of Aspect 58, wherein the stacking the second outer layer comprises: stacking the second outer layer 30 with the second of the plurality of intermediate layers 20.2, such that the fifth conductor 105 of the second outer layer 30 is disposed adjacent the corresponding instance of the fourth conductor 104.2 of the second of the plurality of intermediate layers 20.2.

Aspect 60: A method of producing an inductive coil assembly 1000, the method comprising: forming a first outer layer 10 comprising a first conductor 101 bonded to a first side of a first ceramic 201, and a second conductor 102 bonded to a second side of the first ceramic 201, wherein the second side of the first ceramic 201 opposes the first side of the first ceramic 201, wherein the first conductor 101 has a thickness T, and wherein the second conductor 102 has a thickness (y)T; forming N(i) intermediate layers 20, where (i) is an integer from 1 to M, where N(i) represents a discrete one of an i-th intermediate layer 20.1, 20.2, 20.3, and where N(M) is a defined maximum number of the N(i) intermediate layers 20, wherein each one of the N(i) intermediate layers 20 comprises: an (i) instance of a third conductor 103.1, 103.2 103.3 bonded to a first side of a corresponding (i) instance of a second ceramic 202.1, 202.2, 202.3, and an (i) instance of a fourth conductor 104.1, 104.2, 104.3 bonded to a second side of the corresponding (i) instance of the second ceramic 202.1, 202.2, 202.3, wherein the second side of the corresponding (i) instance of the second ceramic 202.1, 202.2, 202.3 opposes the first side of the corresponding (i) instance of the second ceramic 202.1, 202.2, 202.3, wherein the corresponding (i) instance of the third conductor 103.1, 103.2, 103.3 has a thickness (x)T, and wherein the corresponding (i) instance of the fourth conductor 104.1, 104.2, 104.3 has thickness (y)T; forming a second outer layer 30 comprising a fifth conductor 105 bonded to a first side of a third ceramic 203, and a sixth conductor 106 bonded to a second side of the third ceramic 203, wherein the second side of the third ceramic 203 opposes the first side of the third ceramic 203, wherein the fifth conductor 105 has a thickness (x)T and wherein the sixth conductor 106 has a thickness T; wherein x is equal to or greater than 0 and equal to or less than 1, and wherein x plus y is equal to 1; stacking the N(1) to N(M) intermediate layers 20.1, 20.2, 20.3 with the first outer layer 10 such that a corresponding instance of the third conductor 103.1 of the N(1) intermediate layer 20.1 is disposed adjacent the second conductor 102 of the first outer layer 10; stacking the second outer layer 30 with the N(M) intermediate layer 20.1, 20.2, 20.3 such that the fifth conductor 105 of the second outer layer 30 is disposed adjacent a corresponding instance of the fourth conductor 104.1, 104.2, 104.3 of the N(M) intermediate layer 20.1, 20.2, 20.3; registering the corresponding instance of the third conductor 103.1 of the N(1) intermediate layer 20.1 with the second conductor 102 of the first outer layer 10, and the fifth conductor 105 of the second outer layer 30 with the corresponding instance of the fourth conductor 104.1, 104.2, 104.3 of the N(M) intermediate layer 20.1, 20.2, 20.3; and, directly bonding at least the corresponding instance of the third conductor 103.1 of the N(1) intermediate layer 20.1 to the second conductor 102 of the first outer layer 10, and the fifth conductor 105 of the second outer layer 30 with the corresponding instance of the fourth conductor 104.1, 104.2, 104.3 of the N(M) intermediate layer 20.1, 20.2, 20.3.

Aspect 61: The method of Aspect 60, wherein N(i) intermediate layers 20.1, 20.2, 20.3 comprises an N(i) instance of the intermediate layers 20.1, 20.2 and an N(i+1) instance of the intermediate layers 20.2, 20.3, and wherein the stacking the N(1) to N(M) intermediate layers comprises: stacking the N(i+1) instance of the intermediate layers 20.2, 20.3 with the corresponding N(i) instance of the intermediate layers 20.1, 20.2, such that the corresponding instance of the third conductor 103.2, 103.3 of the N(i+1) instance of the intermediate layers 20.2, 20.3 is disposed adjacent the corresponding instance of the fourth conductor 104.1, 104.2 of the N(i) instance of the intermediate layers 20.1, 20.2.

Aspect 62: The method of Aspect 61, wherein the registering further comprises: registering the corresponding instance of the third conductor 103.2, 103.3 of the N(i+1) instance of the intermediate layers 20.2, 20.3 with the corresponding instance of the fourth conductor 104.1, 104.2 of the N(i) instance of the intermediate layers 20.1, 20.2.

Aspect 63: The method of Aspect 62, wherein the directly bonding further comprises: directly bonding the corresponding instance of the third conductor 103.2, 103.3 of the N(i+1) instance of the intermediate layers 20.2, 20.3 with the corresponding instance of the fourth conductor 104.1, 104.2 of the N(i) instance of the intermediate layers 20.1, 20.2.

Aspect 64: A method of producing an inductive coil assembly 3000, the method comprising: forming N(i) layers 10, where (i) is an integer from 1 to M, where N(i) represents a discrete one of an i-th layer 10.1, 10.2, 10.3, and where N(M) is a defined maximum number of the N(i) layers 10, wherein each one of the N(i) layers 10 comprises: an (i) instance of a first conductor 101.1, 101.2, 101.3 bonded to a first side of an (i) instance of a ceramic 200.1, 200.2, 200.3, wherein a second side of the corresponding (i) instance of the ceramic 200.1, 200.2, 200.3 opposes the first side of the corresponding (i) instance of the ceramic 200.1, 200.2, 200.3; an (i) instance of a second conductor 102.1, 102.2, 102.3 bonded to the corresponding second side of the (i) instance of the ceramic 200.1, 200.2, 200.3; and, wherein the (i) instance of the first conductor 101.1, 101.2, 101.3 has a thickness (x)T, and the (i) instance of the second conductor 102.1, 102.2, 102.3 has a thickness (y)T; stacking and registering the N(1) to N(M) layers 10.1, 10.2, 10.3 with each other, such that for (i=1 to M−1), a corresponding instance of the first conductor 101.2, 101.3 of an N(i+1) layer 10.2, 10.3 is disposed adjacent a corresponding instance of the second conductor 102.1, 102.2 of an N(i) layer 10.1, 10.2; stacking and registering a third conductor 103 with the corresponding instance of the first conductor 101.1 of the N(1) layer 10.1, and a fourth conductor 104 with the corresponding instance of the second conductor 102.2, 102.3 of the corresponding N(M) layer 10.2, 10.3; and, directly bonding at least the third conductor 103 to the corresponding first conductor 101.1 of the N(1) layer 10.1, and the fourth conductor 104 to the corresponding second conductor 102.2, 102.3 of the corresponding N(M) layer 10.2, 10.3, wherein the third conductor 103 has a thickness (y)T, and the fourth conductor 104 has a thickness (x)T: wherein x is equal to or greater than 0 and equal to or less than 1. and wherein x plus y is equal to 1.

1. A method of producing an inductive coil assembly 2000, the method comprising:
forming a first outer layer 10 comprising a first conductor 101 bonded to a first side of a first ceramic 201, wherein a second side of the first ceramic 201 opposes the first side of the first ceramic 201, wherein the first conductor 101 has a thickness T;
forming N(i) intermediate layers 20, where (i) is an integer from 1 to M, where N(i) represents a discrete one of an i-th intermediate layer 20.1, 20.2, 20.3, and where N(M) is a defined maximum number of the N(i) intermediate layers, wherein each one of the N(i) intermediate layers 20 comprises:
an (i) instance of a second conductor 102.1, 102.2, 102.3 bonded to a first side of a corresponding (i) instance of a second ceramic 202.1, 202.2, 202.3, wherein a second side of the corresponding (i) instance of the second ceramic 202.1, 202.2, 202.3 opposes the first side of the corresponding (i) instance of the second ceramic 202.1, 202.2, 202.3, and wherein the corresponding (i) instance of the second conductor 102.1, 102.2, 102.3 has a thickness T;
forming a second outer layer 30 comprising a third conductor 103 bonded to a first side of a third ceramic 203, wherein a second side of the third ceramic 203 opposes the first side of the third ceramic 203, wherein the third conductor 103 has a thickness T;
stacking the N(1) to N(M) intermediate layers 20.1, 20.2, 20.3 with the first outer layer 10 such that a corresponding instance of the second conductor 102.1 of the N(1) intermediate layer 20.1 is disposed adjacent the second side of the first ceramic 201 of the first outer layer 10;
stacking the second outer layer 30 with the corresponding N(M) intermediate layer 20.1, 20.2, 20.3 such that the third conductor 103 of the second outer layer 30 is disposed adjacent a corresponding instance of the second ceramic 202.1, 202.2, 202.3 of the corresponding N(M) intermediate layer 20.1, 20.2, 20.3;
registering the corresponding instance of the second conductor 102.1 of the N(1) intermediate layer 20.1 with the first ceramic 201 of the first outer layer 10, and the third conductor 103 of the second outer layer 30 with the corresponding instance of the second ceramic 202.1, 202.2, 202.3 of the corresponding N(M) intermediate layer 20.1, 20.2, 20.3;
stacking and registering a fourth conductor 104 with the second side of the third ceramic 203 of the second outer layer 30; and
directly bonding at least the corresponding instance of the second conductor 102.1 of the N(1) intermediate layer 20.1 to the first ceramic 201 of the first outer layer 10, and the fourth conductor 104 to the third ceramic 203 of the second outer layer 30.

2. The method of claim 1, wherein the stacking the N(1) to N(M) intermediate layers 20.1, 20.2, 20.3 further comprises:
stacking an (i+1) instance of the intermediate layers 20.2, 20.3 with a corresponding (i) instance of the intermediate layers 20.1, 20.2, such that the corresponding (i+1) instance of the second conductor 102.2, 102.3 of the (i+1) instance of the intermediate layers 20.2, 20.3 is disposed adjacent the corresponding (i) instance of the second ceramic 202.1, 202.2 of the corresponding (i) instance of the intermediate layers 20.1, 20.2.

3. The method of claim 1, wherein:
the first conductor 101, each (i) instance of the second conductor 102, the third conductor 103, and the fourth conductor 104, each form a corresponding structured conductor.

4. The method of claim 3, wherein:
each of the first structured conductor, the (i) instance of the second structured conductor, the third structured conductor, and the fourth structured conductor, is formed by directly bonding the corresponding conductor to the corresponding ceramic, and patterning the corresponding conductor to form the corresponding structured conductor.

5. The method of claim 4, wherein:
the patterning the corresponding conductor defines an electrical path, of the corresponding structured conductor from a first end to a second end of the corresponding structured conductor.

6. The method of claim 5, wherein:
at least one of the electrical paths is electrically contiguous and non-interrupted.

7. The method of claim 4, wherein:
the patterning the corresponding conductor comprises applying a mask to the corresponding conductor, etching an exposed portion of the corresponding conductor, and removing the mask to define an electrical path of the corresponding structured conductor from a first end to a second end of the corresponding structured conductor.

8. The method of claim 4, wherein prior to directly bonding the corresponding conductor to the corresponding ceramic, the method further comprising:
forming a defined electrically conductive path in a non-structured conductor to form the corresponding structured conductor.

9. The method of claim 8, wherein the forming the defined electrically conductive path comprises any one of the following:
mechanically removing material of the non-structured conductor to form the corresponding structured conductor;
mechanically cutting material of the non-structured conductor to form the corresponding structured conductor;
mechanically stamping material of the non-structured conductor to form the corresponding structured conductor;
optically removing material of the non-structured conductor to form the corresponding structured conductor; and
chemically removing material of the non-structured conductor to form the corresponding structured conductor.

10. The method of claim 3, wherein:
each corresponding structured conductor comprises a curved electrical current path.

11. The method of claim 3, wherein:
each corresponding structured conductor comprises a spiral electrical current path.

12. The method of claim 1, wherein the forming of the first outer layer, the N(i) intermediate layers, the second outer layer, or any combination thereof, comprises:
depositing an additive conductive metal in the form of a structured conductor that directly bonds the structured conductor to a corresponding one of the first ceramic, the (i) instance of the second ceramic, and the third ceramic, wherein the corresponding structured conductor defines an electrical path of a corresponding one of the first, the (i) instance of the second, the third, and the fourth, conductor.

13. The method of claim 1, wherein the forming of the N(i) intermediate layers, comprises:
depositing an additive conductive metal in the form of a structured conductor that directly bonds the structured conductor to a corresponding one of the (i) instance of the second ceramic, wherein the corresponding structured conductor defines an electrical path of a corresponding one of the (i) instance of the second conductor.

14. The method of claim 1, wherein:
any instance of the conductor comprises copper or aluminum.

15. The method of claim 1, wherein:
any instance of the ceramic comprises aluminum nitride, HPS zirconia doped ceramic, aluminum dioxide, or silicon dioxide.

16. The method of claim 1, wherein:
thickness T is equal to or greater than 35 microns and equal to or less than 400 microns.

17. The method of claim 1, wherein:
thickness T is equal to or greater than 65 microns and equal to or less than 200 microns.

18. The method of claim 1, wherein:
any instance of the layer has a thickness of equal to or greater than 70 microns and equal to or less than 1000 microns.

19. The method of claim 1, wherein:
any instance of the layer has a thickness of equal to or greater than 70 microns and equal to or less than 500 microns.

20. The method of claim 3, wherein:
any instance of the structured conductor has a C-shaped edge-wound shape.

21. The method of claim 1, wherein:
each instance of the conductor is formed of a same material as another different instance of the conductor.

22. The method of claim 3, further comprising:
providing a first polymer on a same side of the (i) instance of the second ceramic as the corresponding (i) instance of the second structured conductor; and,
providing a second polymer on a same side of the (i+1) instance of the second ceramic as the corresponding (i+1) instance of the second structured conductor.

23. The method of claim 22, wherein:
the first polymer is disposed in an area on the (i) instance of the second ceramic that is void of material of the corresponding (i) instance of the second structured conductor; and,
the second polymer is disposed in an area of the (i+1) instance of the second ceramic that is void of material of corresponding (i+1) instance of the second structured conductor.

24. The method of claim 23, wherein:
the first polymer has a same thickness as the (i) instance of the second structured conductor; and,
the second polymer has a same thickness as the (i+1) instance of the second structured conductor.

25. The method of claim 3, further comprising:
providing a first polymer on a same side of the first ceramic as the first structured conductor;
providing an (i) instance of a second polymer on a same side of the (i) instance of the second ceramic as the corresponding (i) instance of the second structured conductor;
providing an (i+1) instance of a second polymer on a same side of the (i+1) instance of the second ceramic as the corresponding (i+1) instance of second structured conductor;
wherein the first polymer is disposed in an area of the first ceramic that is void of material of the first structured conductor;
wherein the (i) instance of the second polymer is disposed in an area of the (i) instance of the second ceramic that is void of material of the (i) instance of the second structured conductor; and
wherein the (i+1) instance of the second polymer is disposed in an area of the (i+1) instance of the second ceramic that is void of material of the (i+1) instance of the second structured conductor.

26. The method of claim 25, wherein:
the first polymer has a same thickness as the second polymer.

27. The method of claim 26, wherein:
the same thickness is equal to T/2.

28. The method of claim 1, wherein:
the first outer layer, the N(i) intermediate layers, and the second outer layer, form the inductive coil assembly having a plurality of electrical conductor layers, formed by a corresponding one of the first conductor, an (i) instance of the second conductor, the third conductor, and the fourth conductor, and ceramic layers, formed by a corresponding one the first ceramic, an (i) instance of the second ceramic, and the third ceramic, that alternate sequentially with each other.

29. The method of claim 28, wherein:
at least two of every other one of the plurality of electrical conductor layers having the thickness T are electrically connected with each other by way of an electrical connection that traverses an intervening one of the plurality of ceramic layers.

30. The method of claim 28, wherein:
at least two of adjacent ones of the plurality of electrical conductor layers having the thickness T are electrically connected with each other by way of an electrical connection that traverses an intervening one of the plurality of ceramic layers.

31. The method of claim 29, wherein:
the electrical connection includes an integrally formed spacer in the region between adjacent ones of the plurality of plurality of ceramic layers;
the spacer not being electrically connected to a corresponding one of the electrical conductor layer at a corresponding one of the layers.

32. The method of claim 29, wherein:
the electrical connection comprises one or more of an electrically filled or electrically plated via.

33. The method of claim 1, wherein:
the first conductor 101 bonded to the first side of the first ceramic 201, is bonded at a first surface-surface interface;
each (i) instance of the second conductor 102.1, 102.2, 102.3 bonded to the first side of the corresponding (i) instance of the second ceramic 202.1, 202.2, 202.3, is bonded at a corresponding (i) instance of a second surface-surface interface;
the third conductor 103 bonded to the first side of the third ceramic 203, is bonded at a third surface-surface interface; and
the fourth conductor 104 bonded to the third ceramic 203 of the second outer layer 30, is bonded at a fourth surface-surface interface;
the method further comprising:
directly bonding via heating and a direct bond copper process through formation of a copper-oxygen eutectic that wets a corresponding one of the first, second, third, and fourth, surface-surface interface.

34. The method of claim 1, wherein:
the first conductor 101 bonded to the first side of the first ceramic 201, is bonded at a first surface-surface interface;
each (i) instance of the second conductor 102.1, 102.2, 102.3 bonded to the first side of the corresponding (i) instance of the second ceramic 202.1, 202.2, 202.3, is bonded at a corresponding (i) instance of a second surface-surface interface;
the third conductor 103 bonded to the first side of the third ceramic 203, is bonded at a third surface-surface interface; and
the fourth conductor 104 bonded to the third ceramic 203 of the second outer layer 30, is bonded at a fourth surface-surface interface;
the method further comprising:
chemically bonding via application of a bonding agent that wets a corresponding one of the first, second, third, and fourth, surface-surface interface.

35. The method of claim 34, wherein:
the bonding agent comprises one or more of: a prepreg material; a polymer paste; and, a ceramic paste.

36. The method of claim 1, further comprising:
in any instance of the conductor, providing a void that creates an electrical disconnect in the corresponding conductor.

37. The method of claim 36, wherein:
each void in the corresponding conductor of adjacently disposed pairs of the conductor are disposed directly facing each other.

38. The method of claim 37, wherein:
each void in the corresponding conductor of adjacently disposed pairs of the conductor are disposed not directly facing, but offset with respect to, each other.

39. The method of claim 36, wherein:
each void in the corresponding conductor of adjacently disposed pairs of the conductor comprise equal gap dimensions.

40. The method of claim 36, wherein:
each void in the corresponding conductor of adjacently disposed pairs of the conductor comprise non-equal gap dimensions.

41. The method of claim 33, further comprising:
filling one or more of any instance of the void with a dielectric material.

42. The method of claim 1, further comprising:
forming the first outer layer, the N(i) intermediate layers, and the second outer layer, to define an A-layer construct and a B-layer construct that alternate with each other in an arrangement of stacked A-B-A-B layers or B-A-B-A layers.

43. The method of claim 1, further comprising:
forming the first conductor, each (i) instance of the second conductor, the third conductor, and the fourth conductor, to define an A-conductor construct and a B-conductor construct that alternate with each other in an arrangement of stacked A-B-A-B conductors or B-A-B-A conductors, with corresponding ones of the first ceramic, an (i) instance of the second ceramic, and the third ceramic, disposed between adjacent one of the A and B conductors.

44. The method of claim 43, wherein:
each A-conductor and each B-conductor comprise a structured conductor in the form of a plurality of windings having a first outer end and a second inner end;
the first outer end of an A-conductor is electrically connected to a respective first outer end of a next adjacent A-conductor; and
the second inner end of a B-conductor is electrically connected to a respective second inner end of a next adjacent B-conductor.

45. The method of claim 44, wherein:
at least one of the A-conductor and the B-conductor are each formed with a step in the electrical path, on one or more of the windings.

46. The method of claim 45, wherein:
the step is oriented in either a z-direction, or in an x-y plane of an orthogonal x-y-z coordinate system.

47. The method of claim 45, wherein:
the A-conductor comprises an electrical disconnect between the corresponding first outer end and the second inner end that forms a third intermediary end and a fourth intermediary end with an electrical gap therebetween;
the third intermediary end is electrically connected to the first outer end; and
the fourth intermediary end is electrically connected to the second inner end.

48. The method of claim 47, wherein:
the first outer end and the second inner end of an A-conductor are electrically connected to respective ones of the first outer end and the second inner end of a next adjacent A-conductor.

49. The method of claim 45, wherein:
corresponding ones of the electrically connected conductors are electrically connected by way of electrically filled or electrically plated vias.

50. The method of claim 45, wherein:
corresponding ones of the electrically connected conductors are electrically connected by way of edgewise electrical connections.

51. The method of claim 45, wherein:
the respective plurality of windings has a curved or circular shape, as observed in a plan view of the corresponding layer.

52. The method of claim 45, wherein:
the respective plurality of windings has a rectangular or square shape, as observed in a plan view of the corresponding layer.

53. The method of claim 1, wherein:
any instance of the registering comprises use of one or more registration pins.

54. The method of claim 53, further comprising:
placing the one or more registration pins in a location such that the one or more registration pins pass through all instances of the ceramic.

55. The method of claim 54, further comprising:
placing the one or more registration pins in a location such that the one or more registration pins do not pass through any instance of the conductor.
